(19) United States
(12) Patent Application Publication
(10) Pub. No.: US 2012/0085919 A1
(43) Pub. Date: Apr. 12, 2012

(54) APPARATUS AND METHODS FOR PATTERN GENERATION

(76) Inventors: Shinichi KOJIMA, Cupertino, CA (US); Christopher F. BEVIS, Los Gatos, CA (US); Allen M. CARROLL, San Jose, CA (US)

(21) Appl. No.: 12/901,217

(22) Filed: Oct. 8, 2010

(51) Int. Cl. H01J 3/14

(52) U.S. Cl. 250/396 R

(57) ABSTRACT

One embodiment relates to an apparatus for writing a pattern on a target substrate. The apparatus includes a plurality of arrays of pixel elements, each array being offset from the other arrays. In addition, the apparatus includes a source and lenses for generating an incident beam that is focused onto the plurality of arrays, and circuitry to control the pixel elements of each array to selectively reflect pixel portions of the incident beam to form a patterned beam. The apparatus further includes a projector for projecting the patterned beam onto the target substrate. Other features, aspects and embodiments are also disclosed.

### STATEMENT REGARDING FEDERALLY SPONSORED RESEARCH OR DEVELOPMENT

The invention described herein was made with Governmental support under contract number HR0011-07-9-0007 awarded by the Defense Advanced Research Projects Agency. The Government may have certain rights in the invention.

### BACKGROUND

1. Technical Field

The present invention relates generally to pattern generation technology that may be applied in an optical or a charged-particle apparatus.

2. Description of the Background Art

A pattern generator may comprise an array of pixel elements which may be utilized to generate a pattern on a substrate using an optical or an electron (or other charged-particle) beam.

A pattern generator using an electron beam may have, for example, pixel elements comprising conductive elements (micro-lenslets) to which voltages may be controllably applied. When a substantially uniform electron beam is mirrored from such a pattern generator, the pixel elements with a negative applied voltage may reflect (mirror) its pixel portion of the beam, while those pixel elements with a positive applied voltage may absorb its pixel portion of the beam. As a result, the reflected electron beam has a pattern imposed on it which corresponds to the pattern of voltages on the pattern generator. The reflected electron beam may then be projected onto a substrate so as to transfer the pattern to the substrate (for example, onto a resist layer on the surface of the substrate).

A pattern generator using an optical beam may have, for example, pixel elements comprising individually tiltable micro-mirrors. When a substantially uniform optical beam is mirrored from such a pattern generator, the untilted mirrors may reflect (mirror) its pixel portion of the beam, while the tilted mirrors may deflect its pixel portion of the beam. As a result, the reflected optical beam has a pattern imposed on it which corresponds to the pattern of untilted/tilted micro-mirrors on the pattern generator. Alternatively, instead of tiltable micro-mirrors, spatial light modulator devices may be used to controllably reflect or diffract pixel portions of the beam. The reflected optical beam may then be projected onto a substrate so as to transfer the pattern to the substrate (for example, onto a resist layer on the surface of the substrate).

### BRIEF DESCRIPTION OF THE DRAWINGS

FIG. 1A is a diagram depicting a conventional array of pixel element devices.

FIG. 1B is a diagram depicting an example pattern which may be desired to be generated by the conventional device array shown in FIG. 1A.

FIGS. 2A-2K comprise a sequence of diagrams depicting the generation of the example pattern of FIG. 1B by the conventional device array of FIG. 1A.

FIG. 3 is a timing diagram corresponding to the sequence of diagrams shown in FIGS. 2A-2K.

FIG. 4A is a diagram depicting a high-density array of pixel element devices that may be impractical to implement due to the size of the underlying transistor cells.

FIG. 4B is a diagram depicting an example pattern which may be desired to be generated by the high-density array shown in FIG. 4A.

FIG. 5 is a diagram depicting two offset arrays of pixel element devices that effectively functions as a high-density interlaced array in accordance with an embodiment of the invention.

FIGS. 6A-6K comprise a sequence of diagrams depicting the generation of the example pattern of FIG. 4 by the two offset arrays of FIG. 5 in accordance with an embodiment of the invention.

FIG. 7 is a timing diagram corresponding to the sequence of diagrams in FIGS. 6A-6K.

FIG. 8A is a diagram depicting another high-density array of pixel element devices that may be impractical to implement due to the size of the underlying transistor cells.

FIG. 8B is a diagram depicting an example pattern which may be desired to be generated by the high-density array shown in FIG. 8A.

FIG. 9 is a diagram depicting four offset arrays of pixel element devices that effectively functions as a high-density array in accordance with an embodiment of the invention.

FIGS. 10A-10Q comprise a sequence of diagrams depicting the generation of the example pattern of FIG. 8B by the four offset arrays of FIG. 9 in accordance with an embodiment of the invention.

FIGS. 11A and 11B provide a timing diagram corresponding to the sequence of diagrams in FIGS. 10A-10Q.

FIG. 12 is a schematic diagram of an example electron beam apparatus in which an embodiment of the invention may be implemented.

FIGS. 13A and 13B are diagrams illustrating the basic operation of a dynamic pattern generator.

### SUMMARY

One embodiment relates to an apparatus for writing a pattern on a target substrate. The apparatus includes a plurality of arrays of pixel elements, each array being offset from the other arrays. In addition, the apparatus includes a source and lenses for generating an incident beam that is focused onto the plurality of arrays, and circuitry to control the pixel elements of each array to selectively reflect pixel portions of the incident beam to form a patterned beam.

The apparatus further includes a projector for projecting the patterned beam onto the target substrate.

Another embodiment relates to a method for writing a pattern onto a target substrate. An incident beam is generated that is focused onto the plurality of arrays. Pixel elements of a plurality of arrays are controlled to selectively reflect pixel portions of the incident beam to form a patterned beam. The positions of the pixel elements of each array are offset from the positions of the pixel elements of the other array(s).

Other embodiments, aspects and feature are also disclosed.

### DETAILED DESCRIPTION

As described above, a beam pattern generator may comprise an array of controllable pixel elements formed over an integrated circuit. The integrated circuit may use transistor circuitry underneath each pixel element to drive voltages to create a contrast pattern within the reflected beam. The patterned beam may then be transferred, demagnified (shrunken), and projected onto a target substrate by a projection system. The target substrate may comprise, for example, a resist-coated semiconductor wafer to be exposed to the pattern for purposes of lithography.

The spatial pitch between pixel elements of a pattern generator is generally limited by the cell size of the transistor circuitry underneath. This limitation means that there is effectively a minimum spatial pitch between pixel elements. Applicants have determined that this minimum spatial pitch between pixel elements at the pattern generator is disadvantageous and causes an efficiency issue.

For example, semiconductor device technology may require a minimum cell size of greater than one micron for the transistor circuitry underneath each pixel element. As such, the minimum pitch between pixel elements formed above the transistor cells must (for practical purposes) also be greater than one micron. In this case, in order to project patterns with features as small as 32 nanometers (for example) onto a target substrate, a demagnification (shrinkage) of approximately one hundred times (100×) or more is required to be performed by the projection system.

As feature size requirements on the target substrates shrink further, the projection system will be required to further demagnify the image of the pixel element array. In addition, at a given numerical aperture, further demagnification results in a loss of efficiency within the projection system. This efficiency loss disadvantageously reduces throughput of an exposure system (for example, for lithography) that utilizes the pattern generator.

To resolve this efficiency issue, the present disclosure provides innovative layouts for the pixel elements of the pattern generator. Surprisingly, the effective spatial pitch of the pattern generator may be shrunk by changing the layout of the pixel elements without changing the actual spatial pitch of the pixel elements.

In the following discussion, the apparatus for generating the pattern operates in a mode which translates the target substrate under the projected beam. As such, the apparatus is configured to translate the pattern across the array in synchronization with the translation of the target substrate. In other words, as the target substrate moves under the projected beam, the pattern embodied in the projected beam is moved in the same direction and speed. As such, the projected beam is able to form the pattern on the substrate while the substrate is in motion.

While the following diagrams represent the pixels by circles, the actual pixel elements in the device array may be of different shapes, such as, for example, square, rectangular, or hexagonal. In addition, the size of the circular areas shown in the diagrams does not necessarily represent the size of the reflective portions of the pixel elements.

Moreover, when a pixel element reflects a pixel portion of the beam, the pixel portion is generally blurred by the time it reaches the target surface. The apparatus may be configured so that the blurring is sufficiently large such that the effective areas illuminated on the target surface by adjacent pixels have some overlap. This effectively fills the “gaps” between adjacent “on” pixels by the time the patterned beam reaches the surface of the target substrate.

Conventional Array

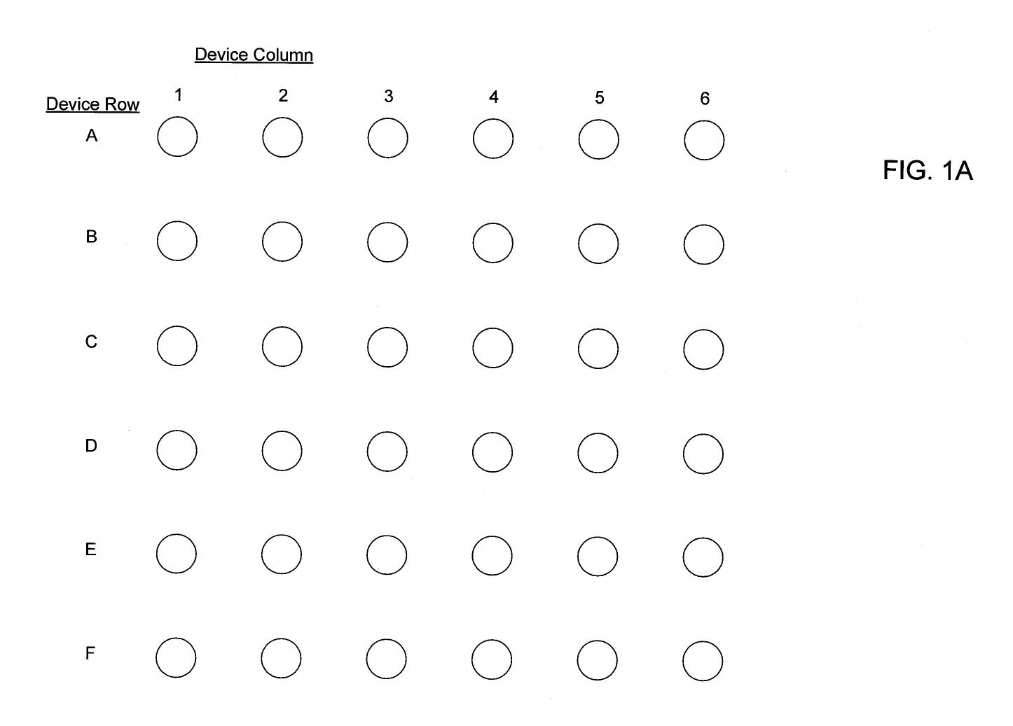

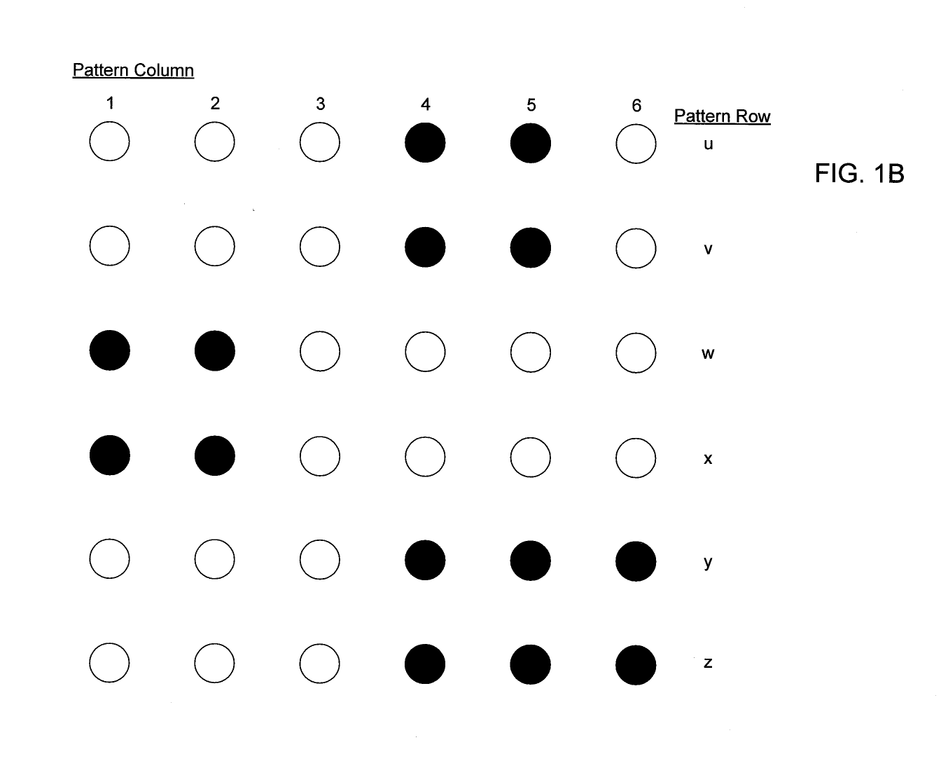

FIG. 1A is a diagram depicting a conventional array of pixel element devices. The small array in FIG. 1A is only 6×6 pixel elements, for ease of illustration and discussion. As shown, the array of pixel element devices may be comprised of six device rows, labeled A through F, and six device columns, labeled 1 through 6. An array used in practical applications will generally be much larger.

FIG. 1B is a diagram depicting an example pattern which may be desired to be generated by the conventional device array shown in FIG. 1A. As shown, the pattern may be composed of six pattern rows, labeled u through z, and six pattern columns, labeled 1 through 6. The black filled circles represent the (unblurred) location pixels of the pattern that are to be written by impingement of the beam, while the unfilled circles represent the (unblurred) location of pixels of the pattern that are to be left unwritten. While the pattern is the same size as the device array in this example, other patterns having a larger (or smaller) number of rows may also be generated by the device array. Note also that, in the actual pattern written on the target substrate, each pixel would be blurred so as to effectively fill gaps between adjacent “on” pixels at the surface of the target substrate.

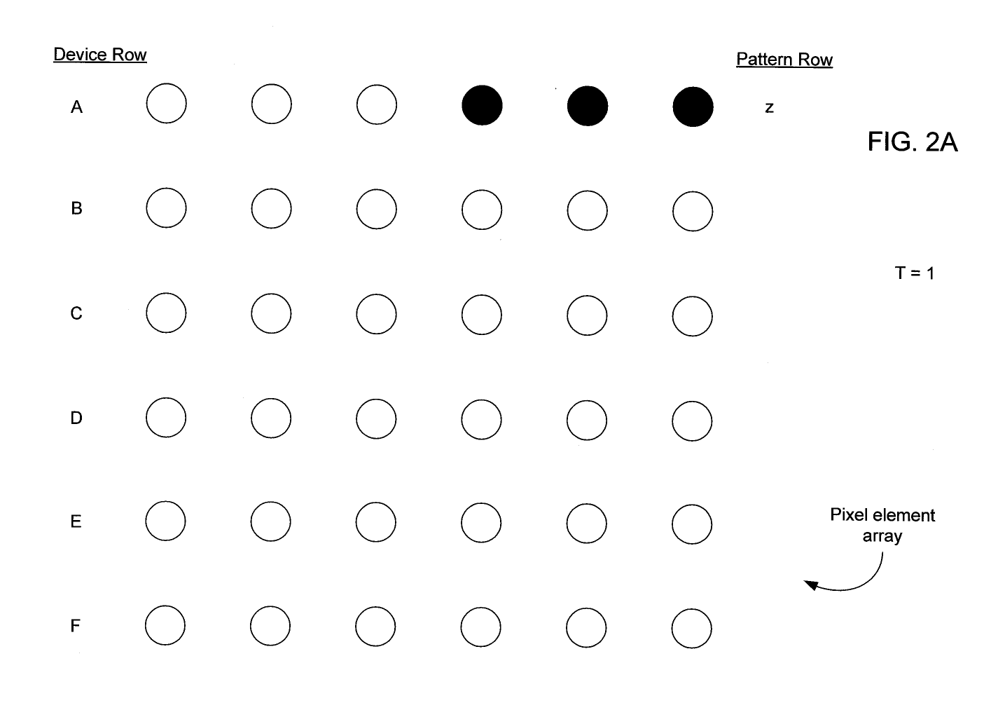

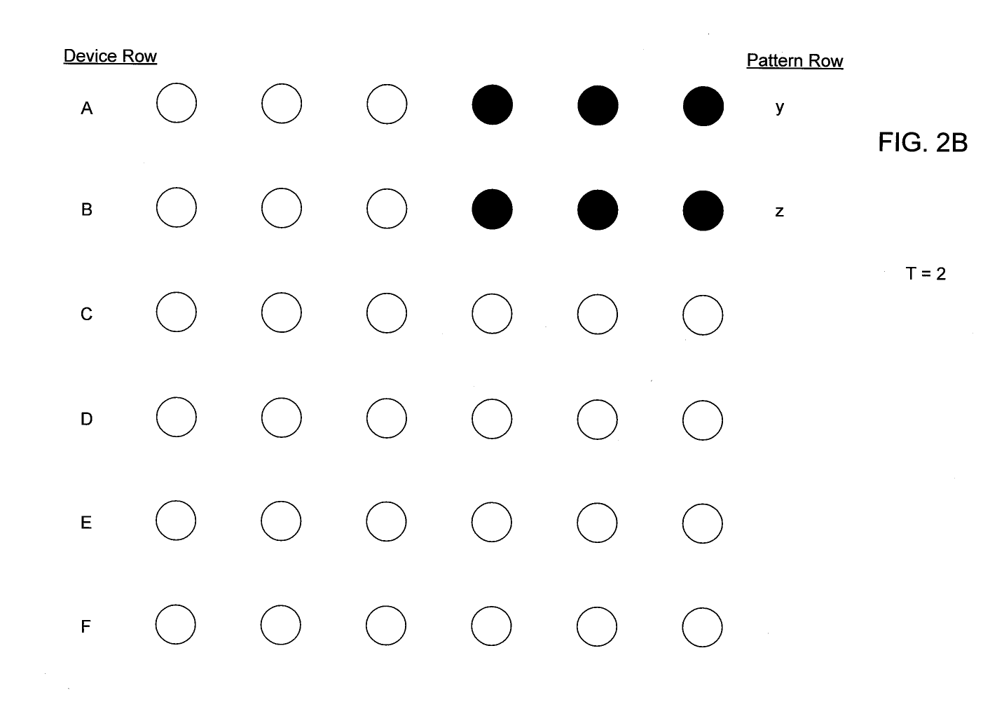

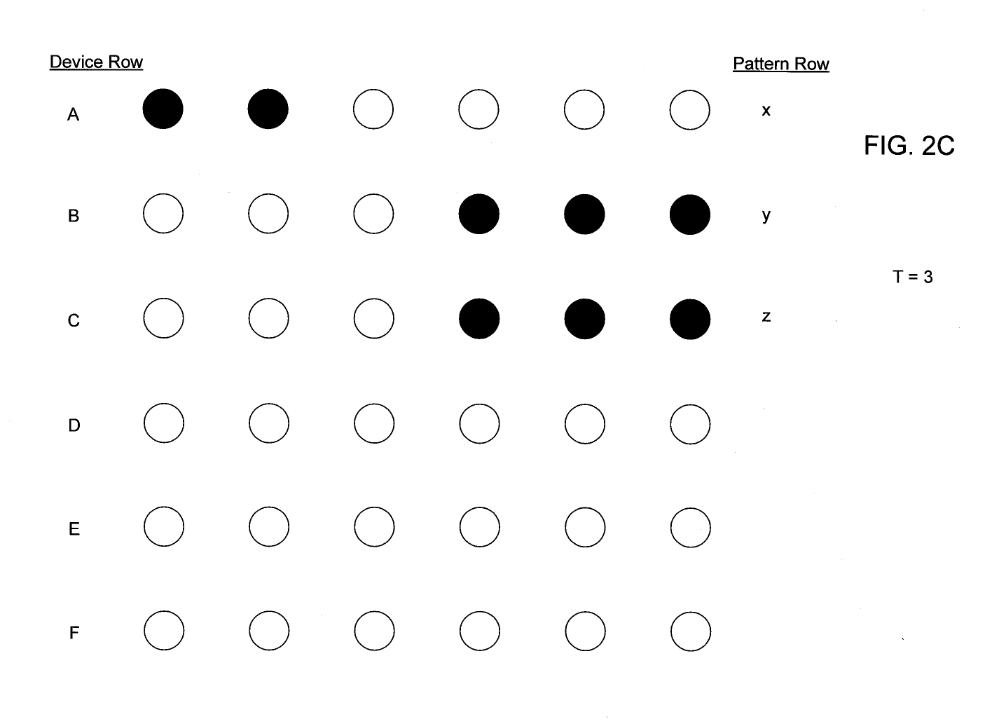

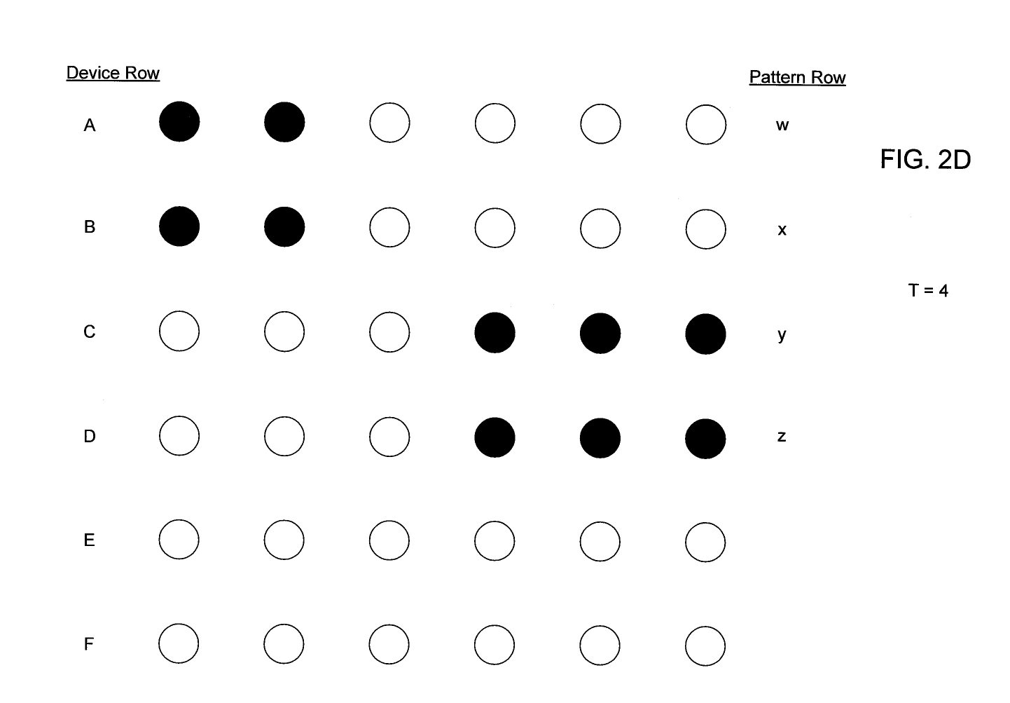

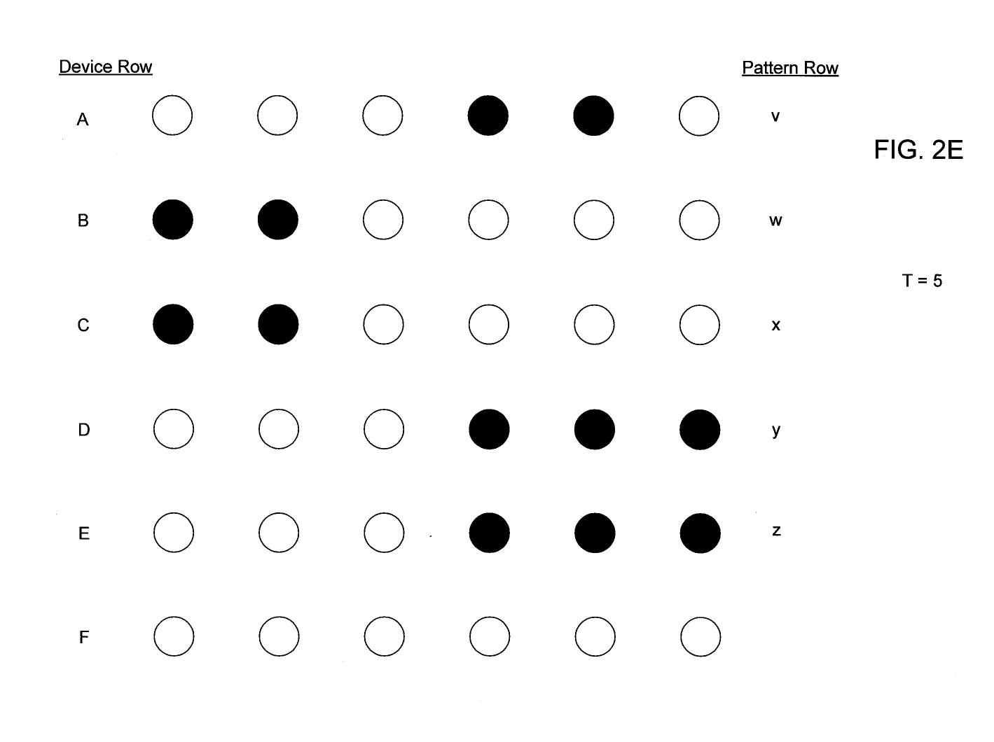

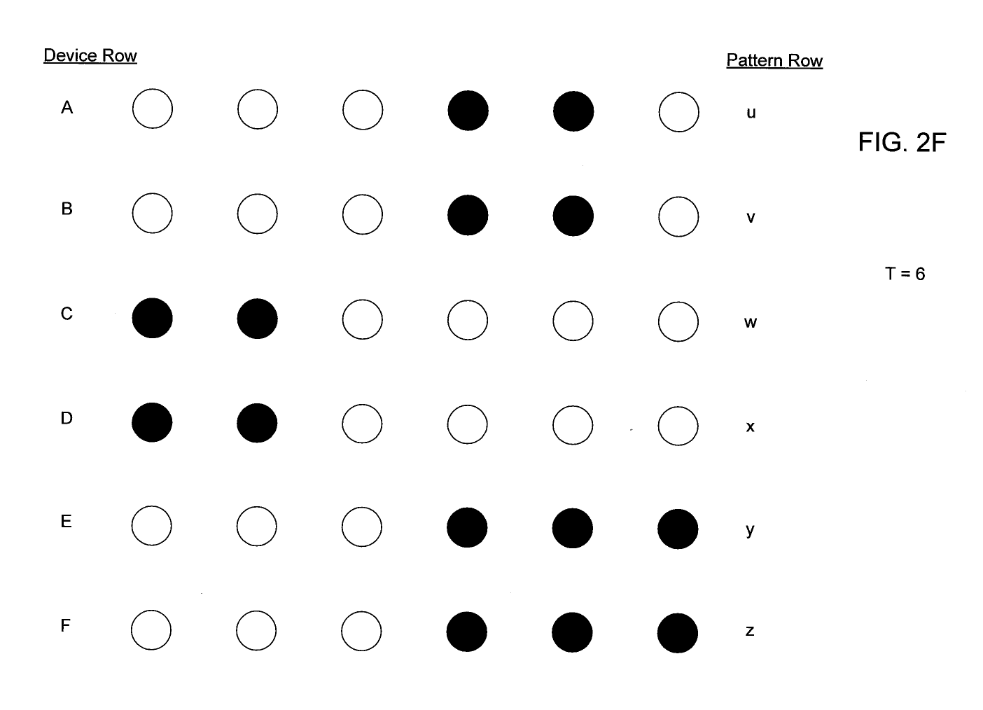

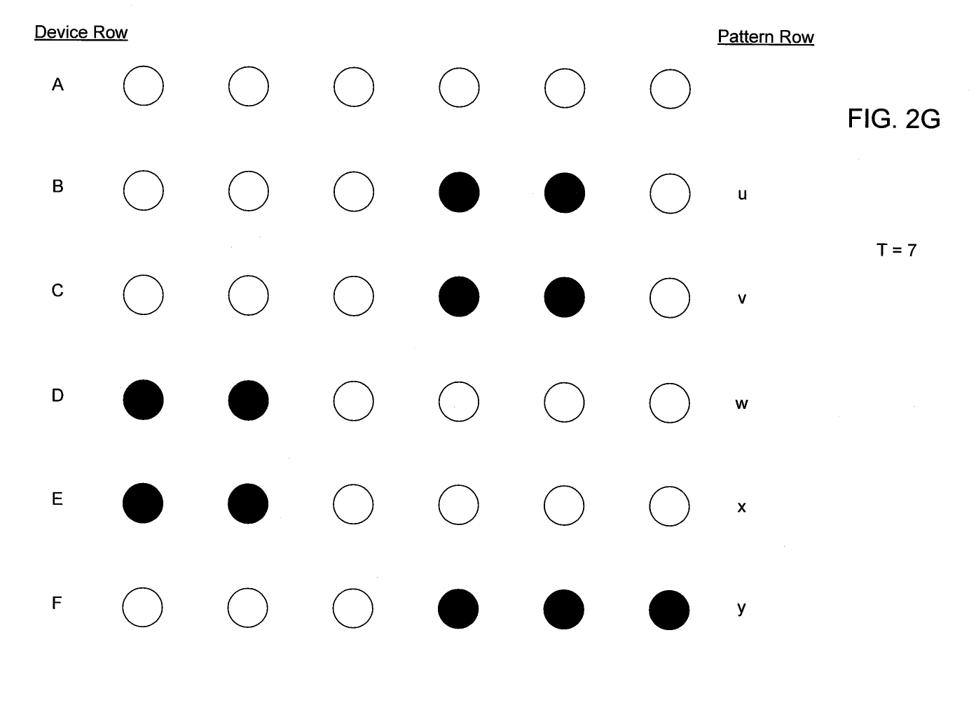

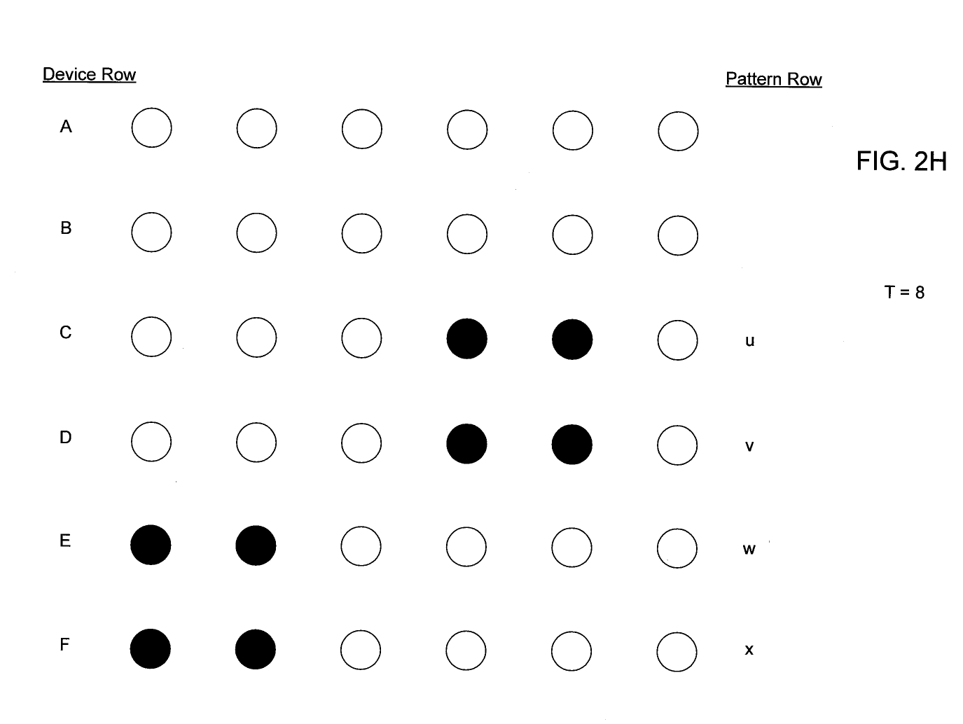

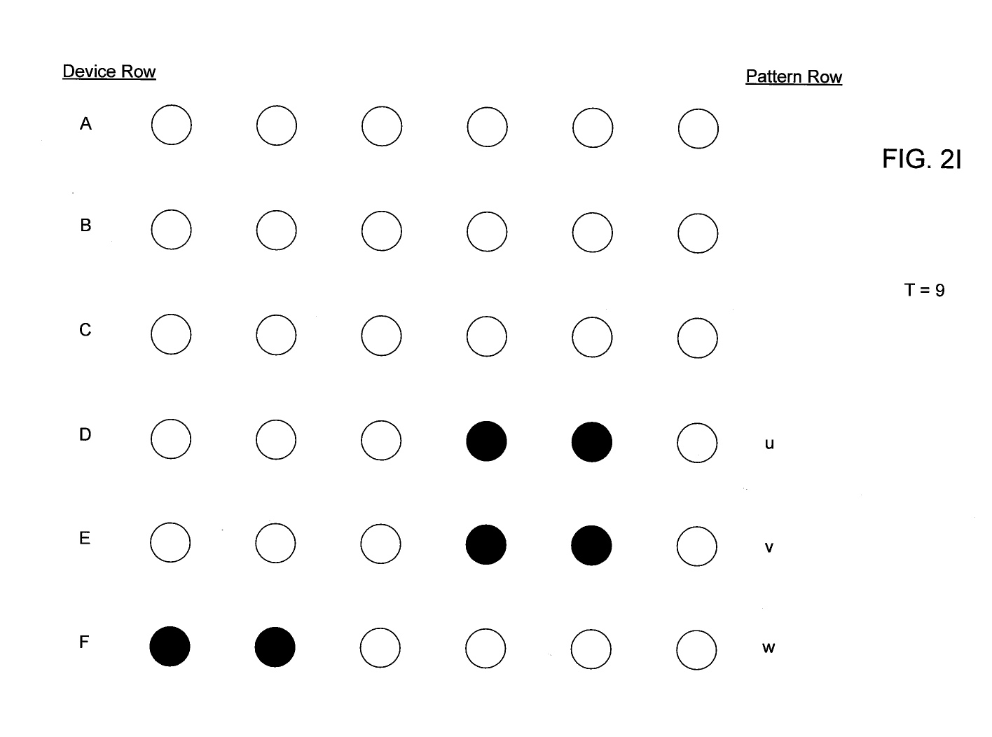

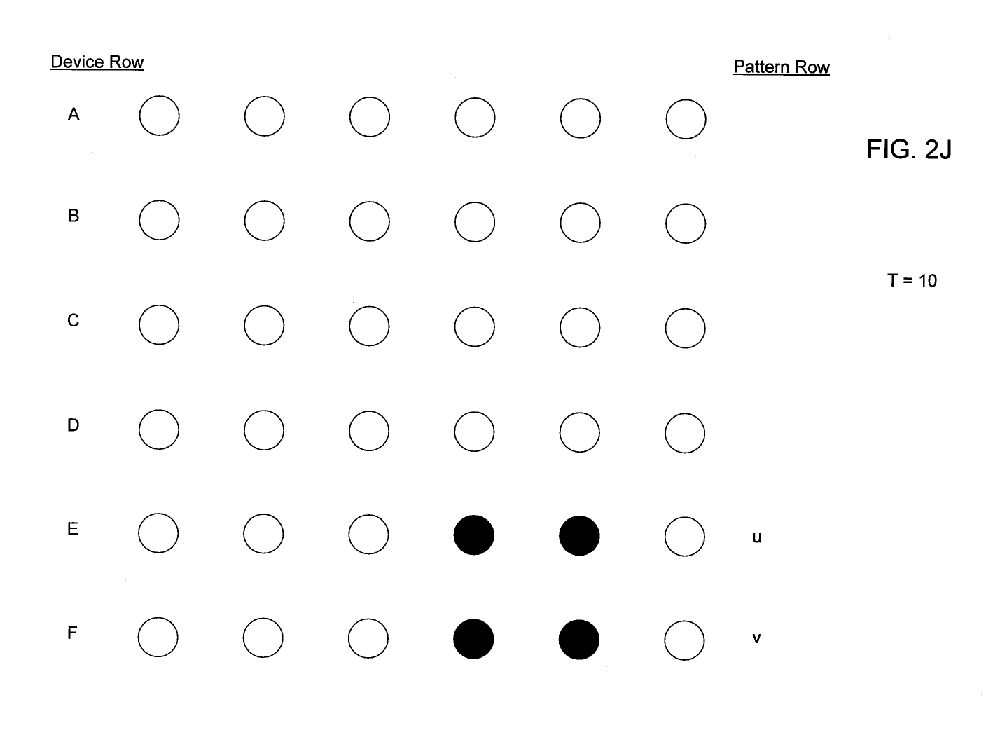

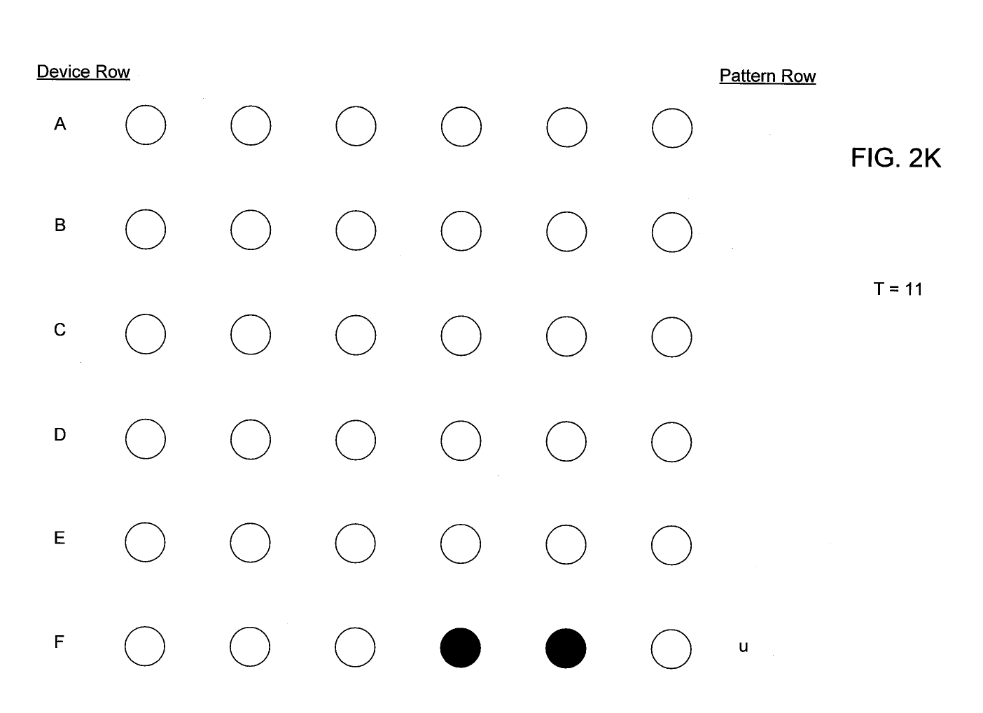

FIGS. 2A-2K comprise a sequence of diagrams depicting the generation of the example pattern of FIG. 1B by the conventional device array of FIG. 1A. In FIGS. 2A-2K, the black filled circles may represent pixel elements that are “on” (i.e. reflecting its pixel portion of the beam so that it impinges upon the target substrate), while the unfilled circles may represent pixel elements that are “off” (i.e. deflecting or diffracting its pixel portion of the beam so that it does not impinge upon the target substrate).

In this sequence of diagrams, the target substrate is being translated under the beam such that the pattern needs to be shifted down one device row for each unit of time T. The sequence of diagrams start with FIG. 2A. FIG. 2A shows that, at time T=1, the pixel elements in device row A are used to generate the pixels from pattern row z.

As shown in FIG. 2B, at time T=2, the pattern is shifted down a row to stay in synchronization with the substrate motion. As such, the pixel elements in device row B are used to generate the pixels from pattern row z, and the pixel elements in device row A are used to generate the pixels from pattern row y.

As shown in FIG. 2C, at time T=3, the pattern is again shifted down a row to stay in synchronization with the substrate motion. As such, the pixel elements in device row C are used to generate the pixels from pattern row z, the pixel elements in device row B are used to generate the pixels from pattern row y, and the pixel elements in device row A are used to generate the pixels from pattern row x.

As shown in FIG. 2D, at time T=4, the pattern is again shifted down a row to stay in synchronization with the substrate motion. As such, the pixel elements in device row D are used to generate the pixels from pattern row z, the pixel elements in device row C are used to generate the pixels from pattern row y, the pixel elements in device row B are used to generate the pixels from pattern row x, and the pixel elements in device row A are used to generate the pixels from pattern row w.

Similarly, as shown in FIG. 2E, at time T=5, the pattern is shifted down a row such that device rows A-E are used to generate pattern rows v-z, respectively. As shown in FIG. 2F, at time T=6, the pattern is shifted down a row such that device rows A-F are used to generate pattern rows u-z, respectively

As shown in FIG. 2G, at time T=7, the pattern is shifted down a row such that device rows B-F are used to generate pattern rows u-y, respectively, and pattern row z is no longer generated by the device array. Similarly, as shown in FIG. 2H, at time T=8, the pattern is shifted down a row such that device rows C-F are used to generate pattern rows u-x, respectively, and pattern rows y and z are no longer generated by the device array. As shown in FIG. 21, at time T=9, the pattern is shifted down a row such that device rows D-F are used to generate pattern rows u-w, respectively, and pattern rows x-z are no longer generated by the device array. As shown in FIG. 2J, at time T=10, the pattern is shifted down a row such that device rows E and F are used to generate pattern rows u and v, respectively, and pattern rows w-z are no longer generated by the device array. Finally, as shown in FIG. 2K, at time T=11, the pattern is shifted down a row such that device row F is used to generate pattern row u, and pattern rows v-z are no longer generated by the device array. Thereafter, at time T=12, the projection of the pattern onto the target substrate is complete, such that none of the pattern rows need to be generated by the device array.

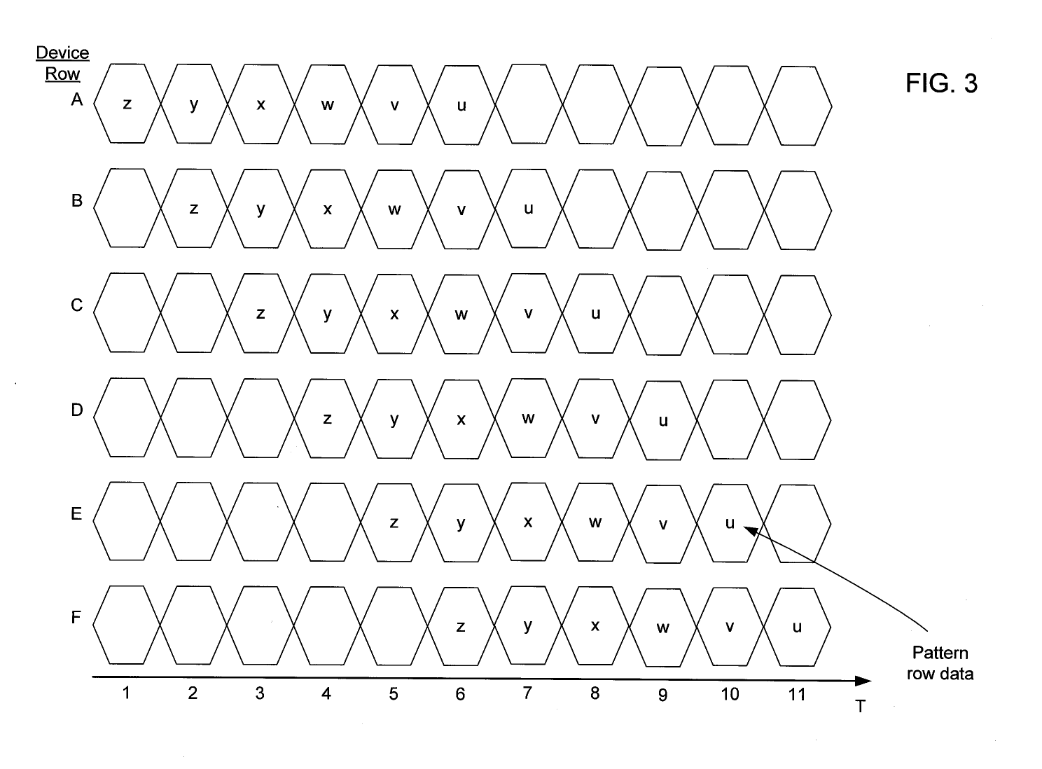

FIG. 3 is a timing diagram corresponding to the sequence of diagrams shown in FIGS. 2A-2K. As seen, at time T=1, device row A is used to generate pattern row z. At time T=2, device rows A and B are used to generate pattern rows y and z, respectively. At time T=3, device rows A-C are used to generate pattern rows x-z, respectively. At time T=4, device rows A-D are used to generate pattern rows w-z, respectively. At time T=5, device rows A-E are used to generate pattern rows v-z, respectively. At time T=6, device rows A-F are used to generate pattern rows u-z, respectively. At time T=7, device rows B-F are used to generate pattern rows u-y, respectively. At time T=8, device rows C-F are used to generate pattern rows u-x, respectively. At time T=9, device rows D-F are used to generate pattern rows u-w, respectively. At time T=10, device rows E and F are used to generate pattern rows u and v, respectively. Finally, at time T=11, device row F is used to generate pattern row u. Thereafter, at time T=12, the projection of the pattern onto the target substrate is complete, such that none of the pattern rows need to be generated by the device array.

First High-Density Array

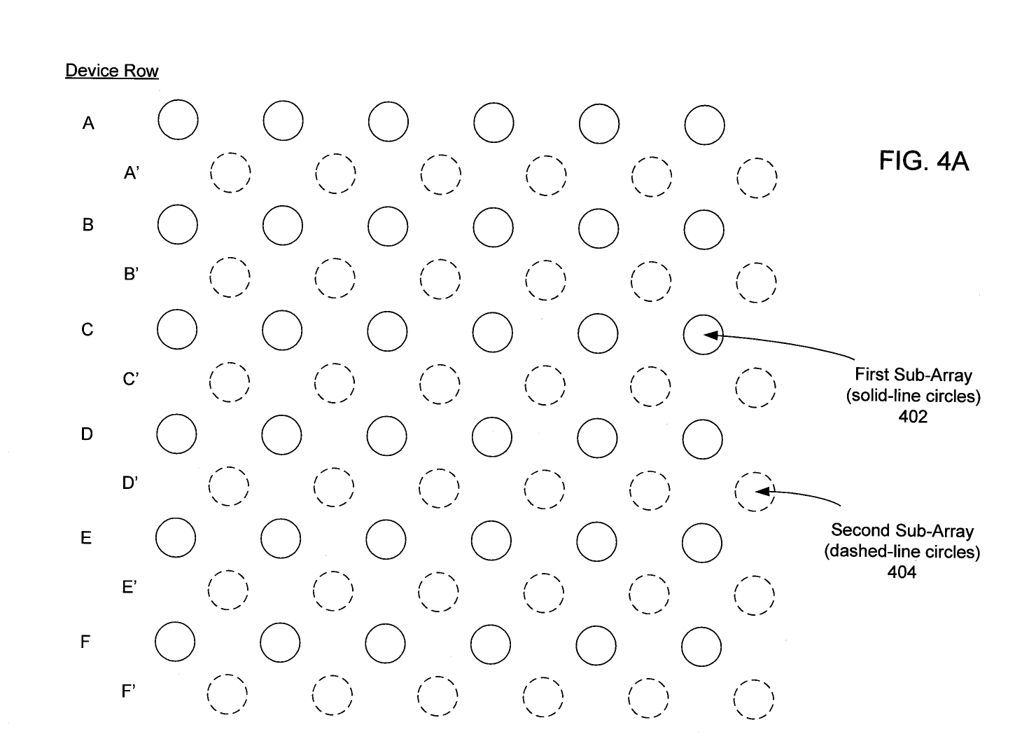

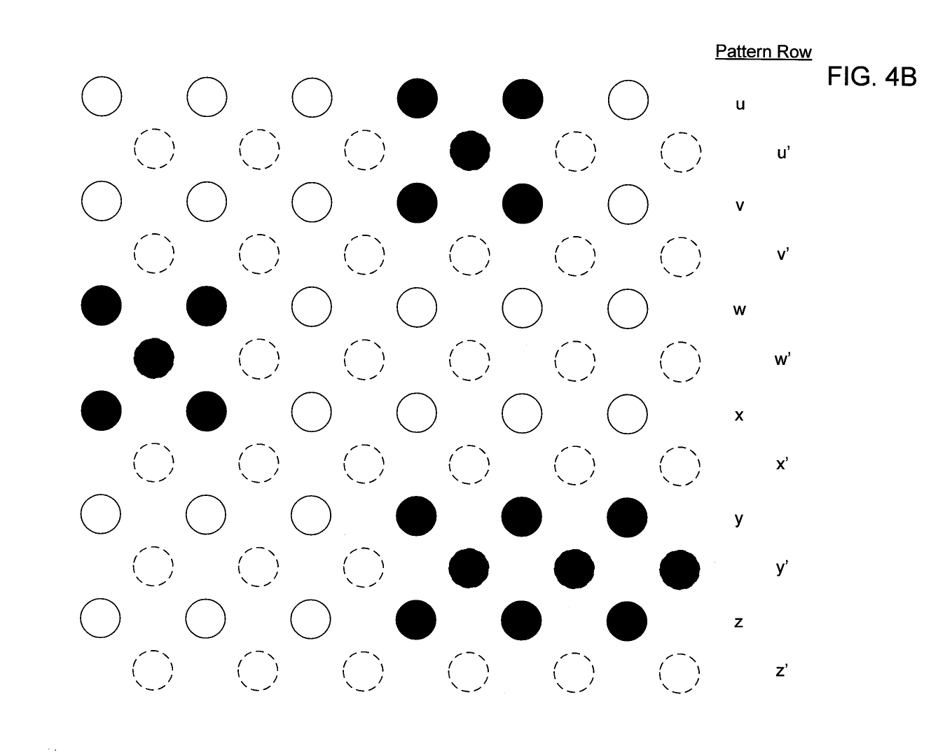

FIG. 4A is a diagram depicting a high-density array of pixel element devices. As shown, the high-density array may be considered to be formed from two sub-arrays. A first sub-array 402 includes device rows A through F, and a second sub-array 404 includes device rows A′ through F′. The first and second sub-arrays are interlaced.

FIG. 4B is a diagram depicting an example pattern which may be desired to be achieved on the high-density device array shown in FIG. 4A. As shown, the pattern may be composed of a first sub-array with six pattern rows u through z and a second sub-array with six pattern rows u′ through z′, where the two sub-arrays are offset so as to be interlaced. The black filled circles represent the (unblurred) location pixels of the pattern that are to be written by impingment of the beam, while the unfilled circles represent the (unblurred) location of pixels of the pattern that are to be left unwritten. While the pattern is the same size as the device array in this example, other patterns having a larger (or smaller) number of rows may also be generated by the device array. Also note that, in the actual pattern written on the target substrate, each pixel would be blurred so as to effectively fill gaps between adjacent “on” pixels at the surface of the target substrate.

Unfortunately, the interlaced device array shown in FIG. 4A may be impractical to implement due to the size of the underlying transistor cells. For example, the size of the underlying transistor cells may be such that the highest possible density of pixel element devices may be the density in one of the sub-arrays. In other words, there may be no space underneath the surface for the transistor cells of the second (interlaced) sub-array. An innovative solution to this problem is described below.

Two Offset Arrays

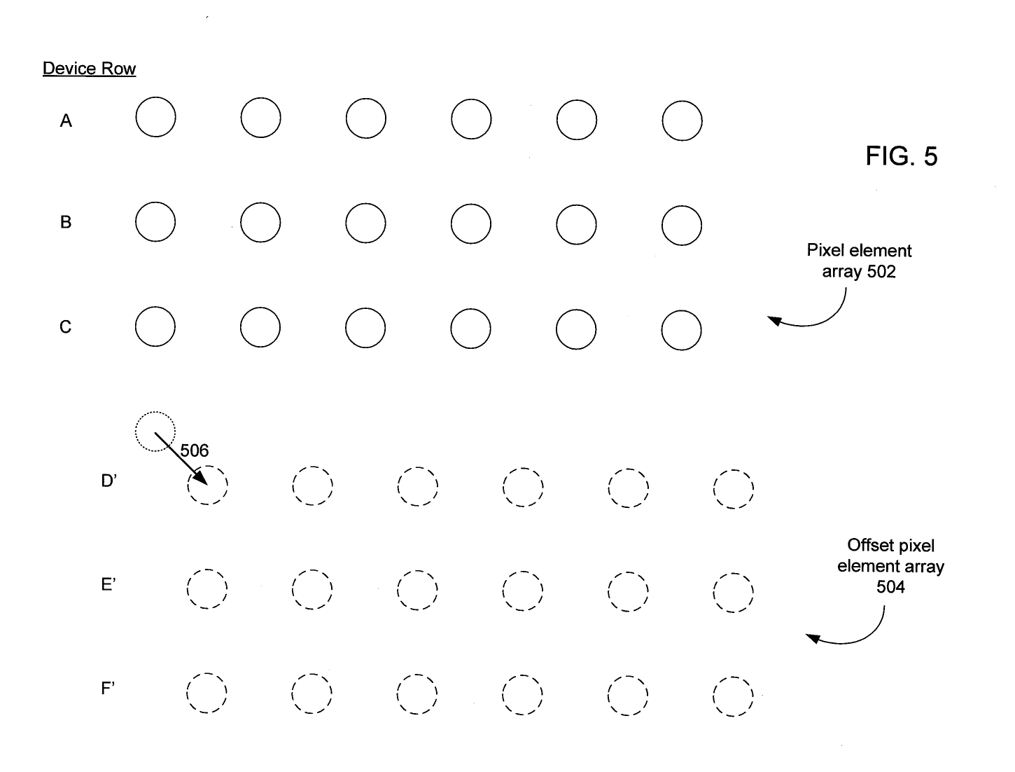

FIG. 5 is a diagram depicting two offset arrays of pixel element devices that effectively functions as a high-density interlaced array in accordance with an embodiment of the invention. As shown, there are two arrays which are offset from each other. In this simple example, the first array 502 includes device rows A through C, and the second array 504 includes device rows D′ through F′. The positions of the pixel elements in the first and second arrays are offset from each other. The offset may be represented by the offset vector 506.

In this simple example, the positions of the pixel elements in the first array 502 correspond to the pixel element positions in rows A through C of the first sub-array 402 in FIG. 4A, while the positions of the pixel elements in the second array 504 correspond to the pixel element positions in rows D′ through F′ of the second sub-array 404 in FIG. 4A.

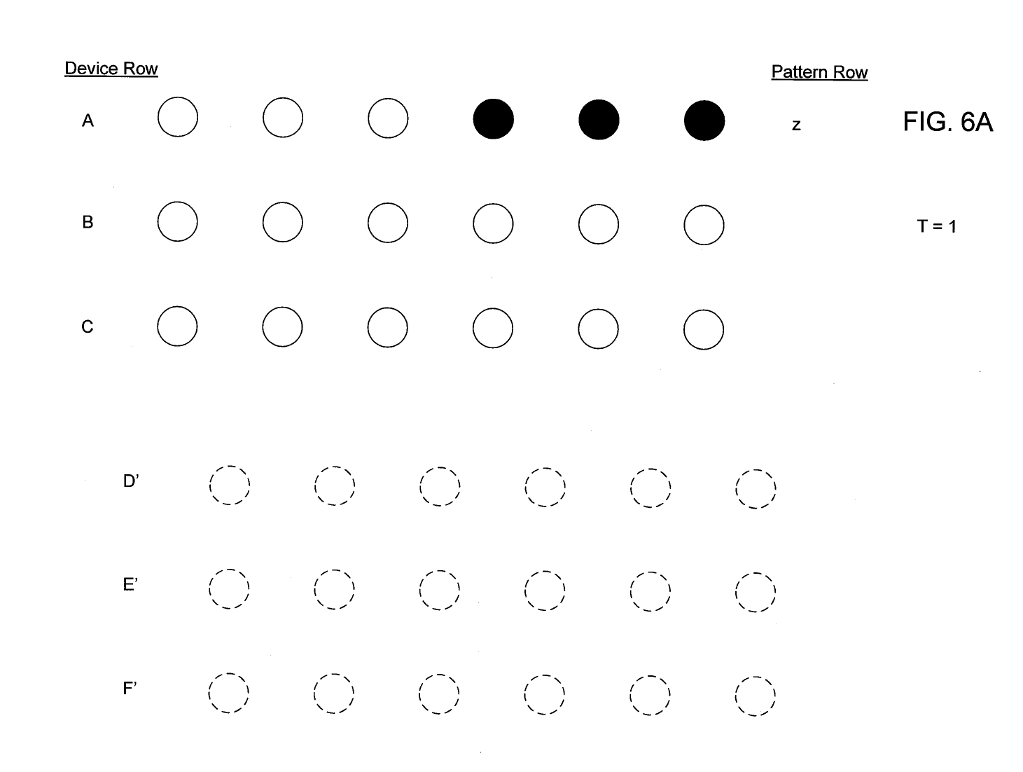

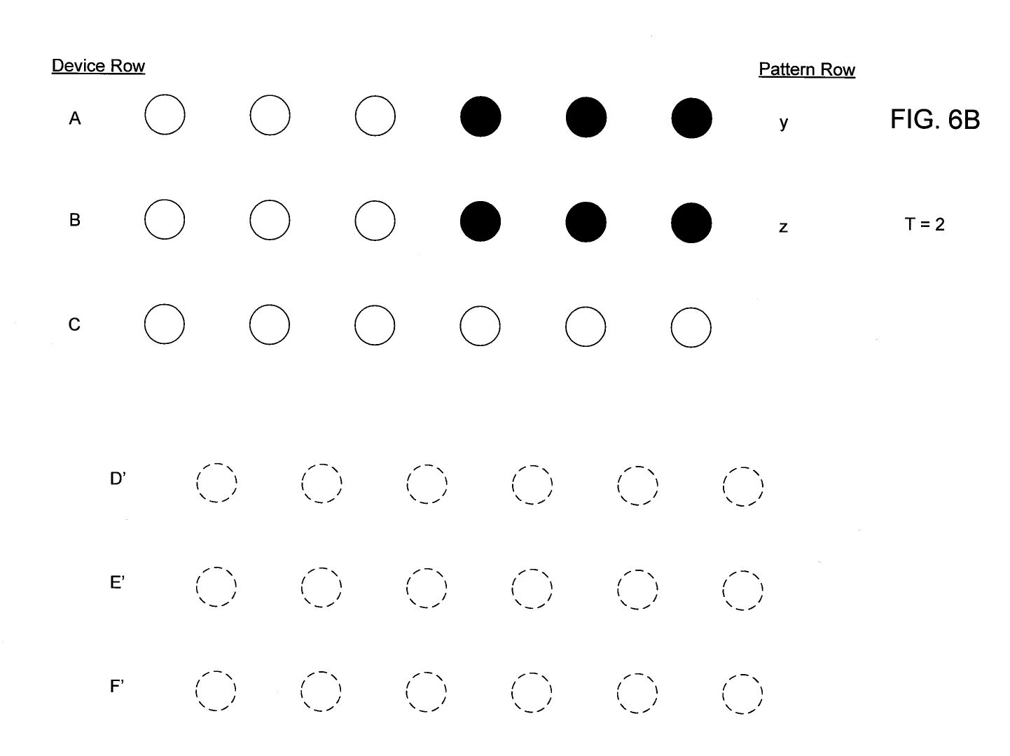

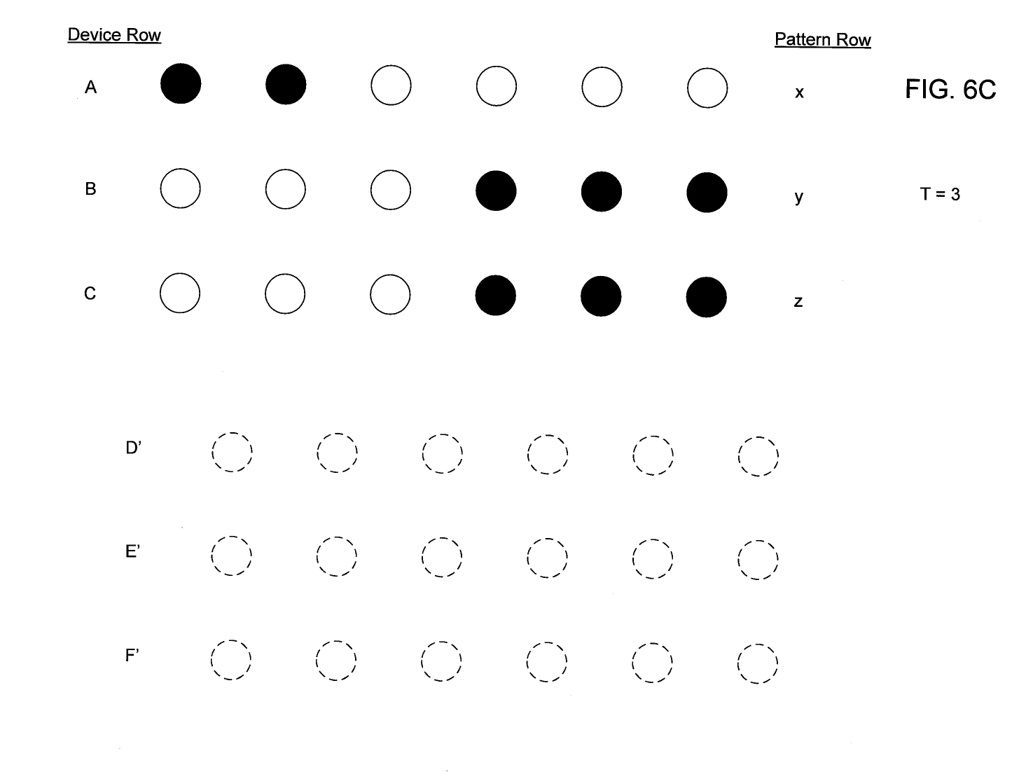

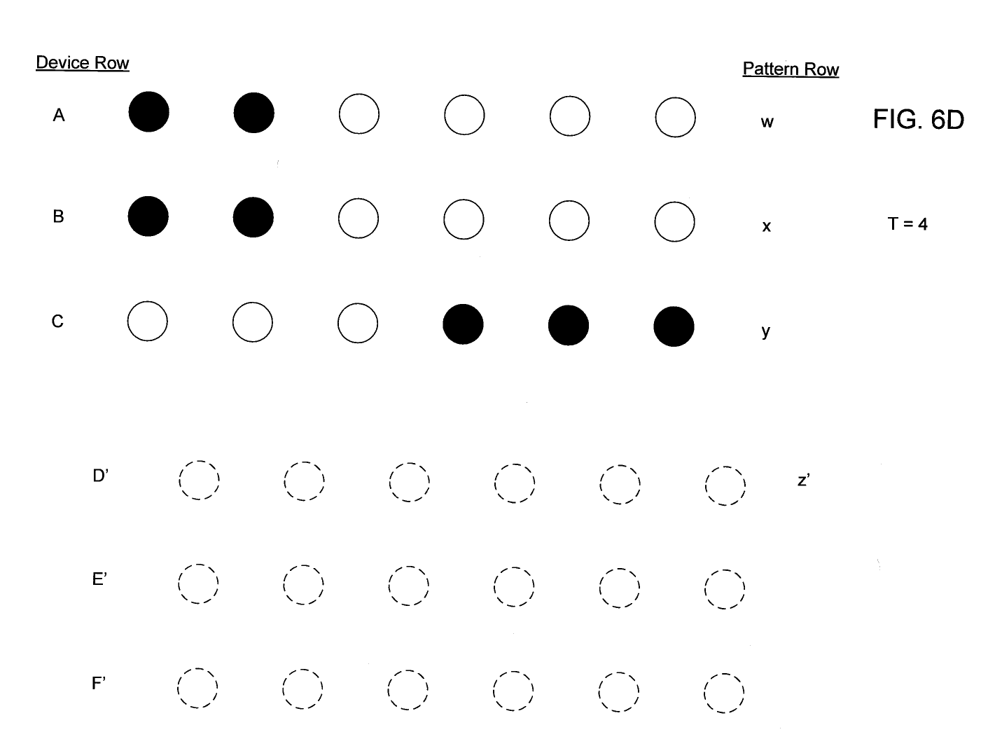

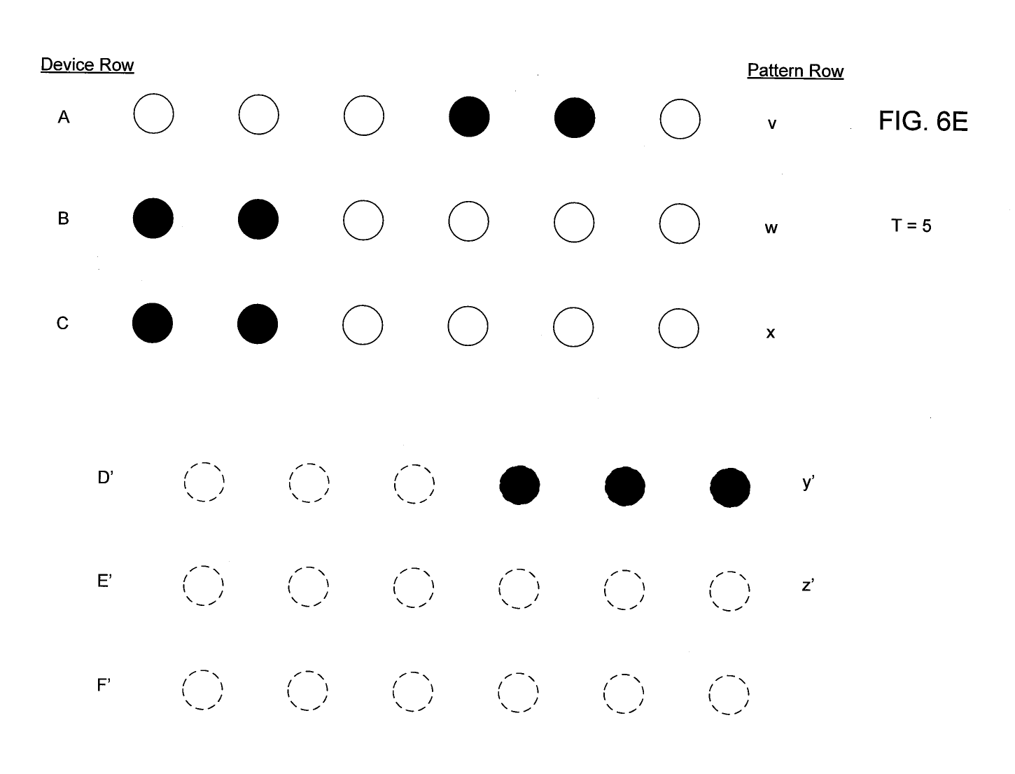

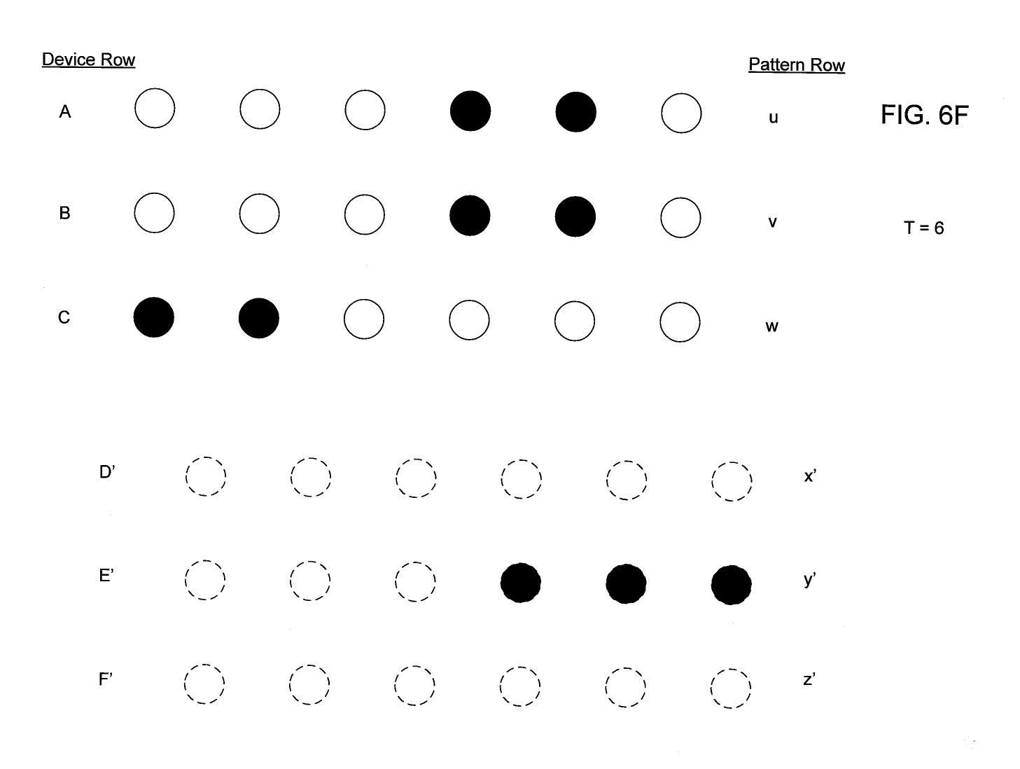

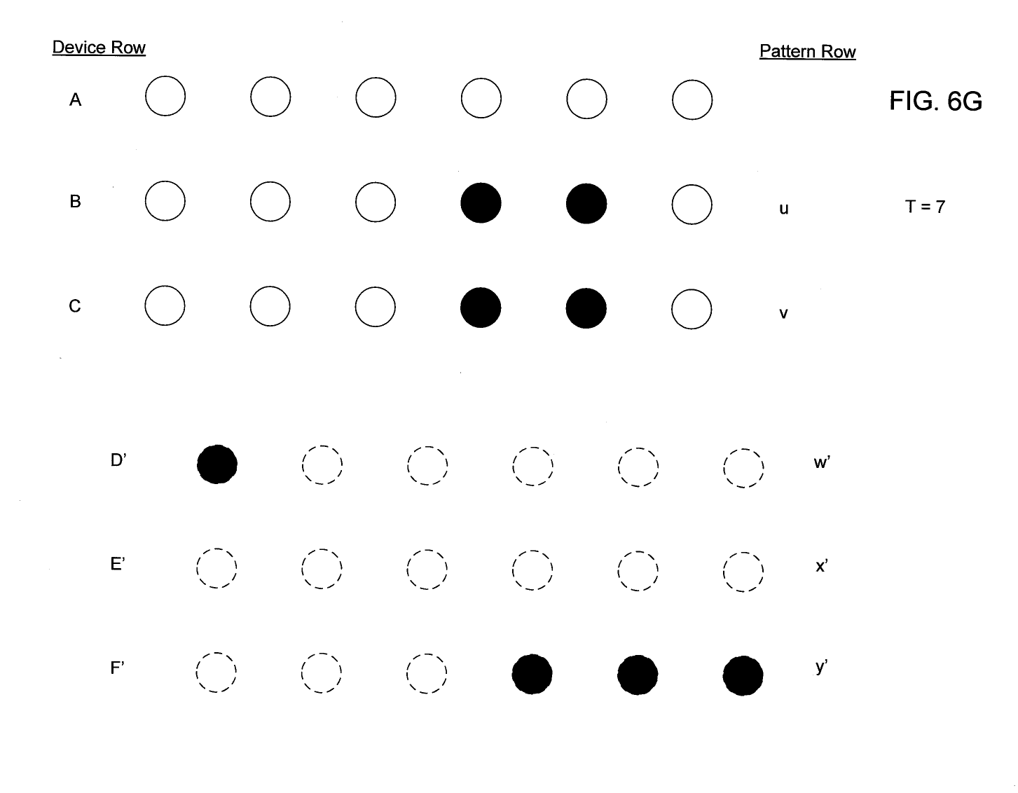

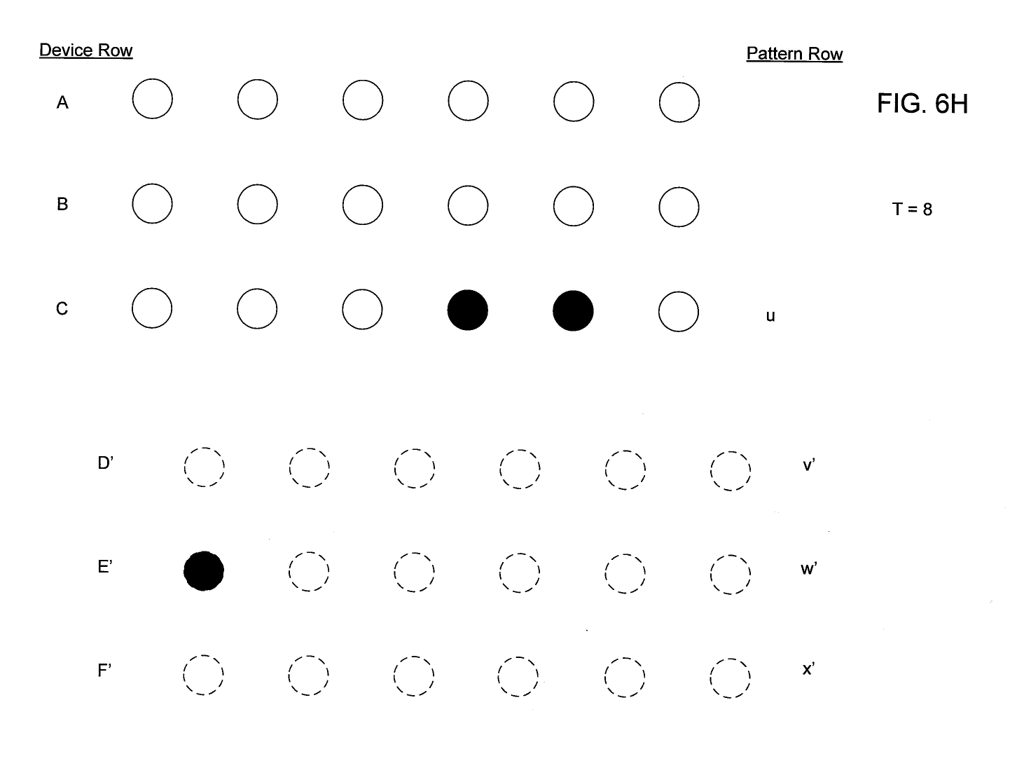

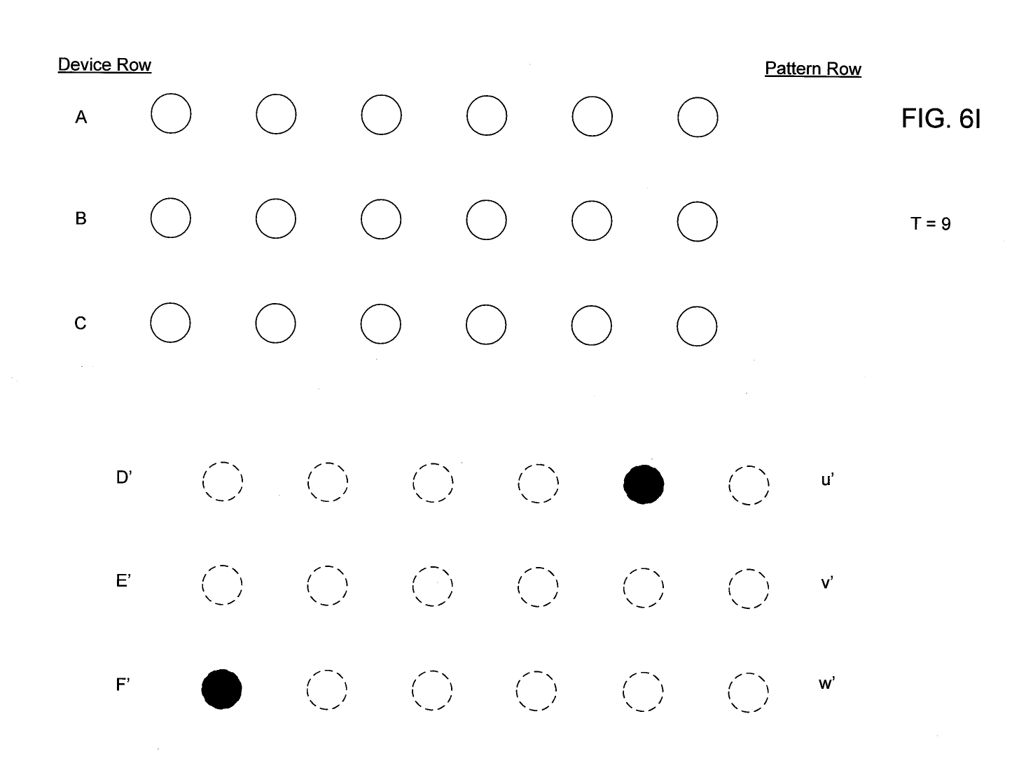

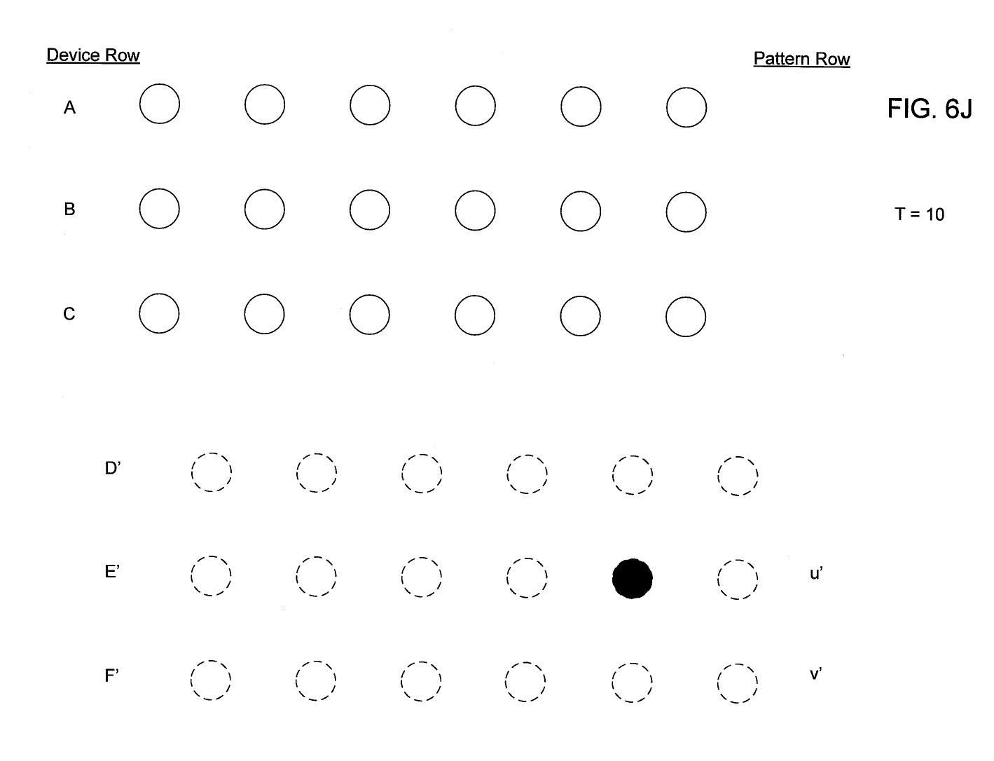

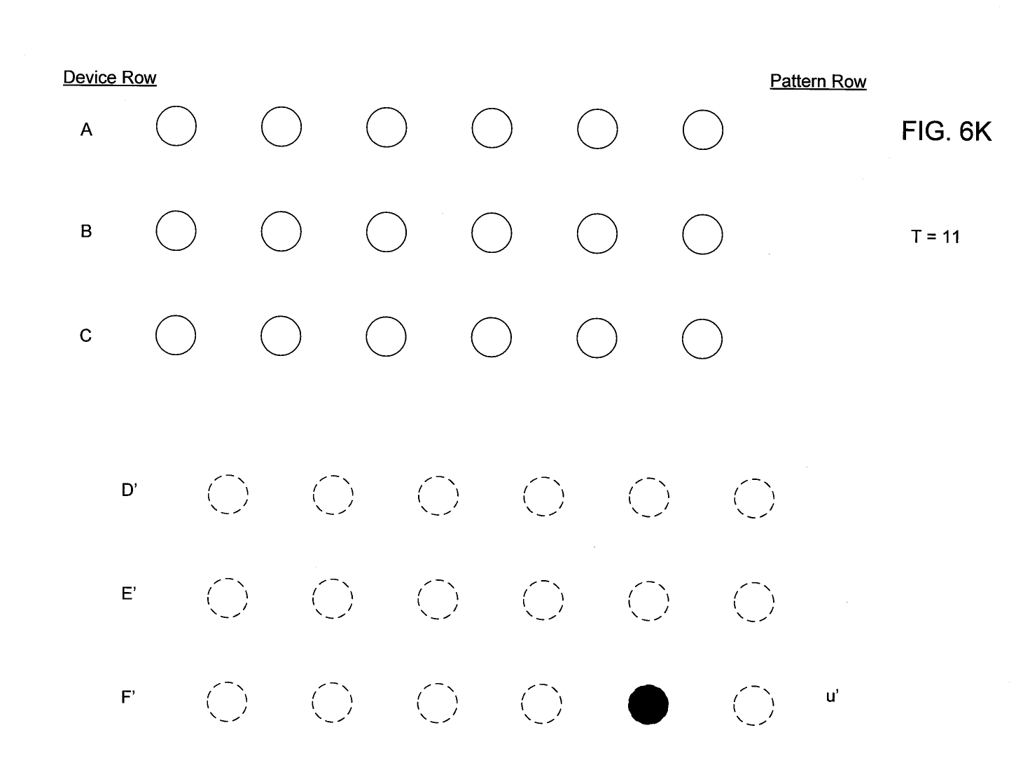

FIGS. 6A-6K comprise a sequence of diagrams depicting the translation of the example pattern of FIG. 4B over the two offset arrays of FIG. 5 in accordance with an embodiment of the invention. In FIGS. 6A-6K, the black filled circles may represent pixel elements that are “on” (i.e. reflecting its pixel portion of the beam so that it impinges upon the target substrate), while the unfilled circles may represent pixel elements that are “off” (i.e. deflecting or diffracting its pixel portion of the beam so that it does not impinge upon the target substrate). In this sequence of diagrams, the target substrate is being translated under the beam such that the pattern needs to be shifted down one device row within each array for each unit of time T.

As shown, only the first array 502 is selectively reflecting pixel portions of the beam at times T=1 to 3. FIG. 6A shows that, at time T=1, the pixel elements in device row A of the first array 502 are used to generate the pixels from pattern row z. As shown in FIG. 6B, at time T=2, the pattern is shifted down a row to stay in synchronization with the substrate motion. As such, the pixel elements in device row B of the first array 502 are used to generate the pixels from pattern row z, and the pixel elements in device row A of the first array 502 are used to generate the pixels from pattern row y. As shown in FIG. 6C, at time T=3, the pattern is again shifted down a row to stay in synchronization with the substrate motion. As such, the pixel elements in device row C of the first array 502 are used to generate the pixels from pattern row z, the pixel elements in device row B of the first array 502 are used to generate the pixels from pattern row y, and the pixel elements in device row A of the first array 502 are used to generate the pixels from pattern row x.

As further shown, from T=4 to T=8, both the first and second arrays (502 and 504) are selectively reflecting pixel portions of the beam. As shown in FIG. 6D, at time T=4, the pattern is again shifted down a row to stay in synchronization with the substrate motion. The pixel elements in device rows A through C in the first array 502 are used to generate the pixels from pattern rows w through y, respectively. In addition, at this time, the pixel elements in device row D′ of the second (offset) array 504 are used to generate the pixels from interlaced pattern row z′. As shown in FIG. 6E, at time T=5, the pattern is shifted down a row such that device rows A-C in the first array 502 are used to generate pattern rows v-x, respectively. In addition, device rows D′ and E′ in the second array 504 are used to generate the interlaced pattern rows y′ and z′, respectively. As shown in FIG. 6F, at time T=6, the pattern is shifted down a row such that device rows A-C in the first array 502 are used to generate pattern rows u-w, respectively. In addition, device rows D′-F′ in the second array 504 are used to generate the interlaced pattern rows x′-z′, respectively. As shown in FIG. 6G, at time T=7, the pattern is shifted down a row such that device rows B and C in the first array 502 are used to generate pattern rows u and v, respectively. In addition, device rows D′-F′ in the second array 504 are used to generate the interlaced pattern rows w′-y′, respectively. As shown in FIG. 6H, at time T=8, the pattern is shifted down a row such that device row C in the first array 502 is used to generate pattern row u. In addition, device rows D′-F′ in the second array 504 are used to generate the interlaced pattern rows v′-x′, respectively.

Lastly, at times T=9 to 11, only the second array 504 is selectively reflecting pixel portions of the beam. As shown in FIG. 21, at time T=9, the pattern is shifted down a row such that device rows D′-F′ in the second array 504 are used to generate interlaced pattern rows u′-w′, respectively. At this time, the first array 502 is no longer selectively reflecting pixel portions of the beam. As shown in FIG. 2J, at time T=10, the pattern is shifted down a row such that device rows E′ and F′ in the second array 504 are used to generate interlaced pattern rows u′ and v′, respectively. Finally, as shown in FIG. 2K, at time T=11, the pattern is shifted down a row such that device row F′ in the second array 504 is used to generate pattern row u′. Thereafter, at time T=12, the projection of the high-density interlaced pattern onto the target substrate is complete, such that none of the pattern rows need to be generated by the offset dual array.

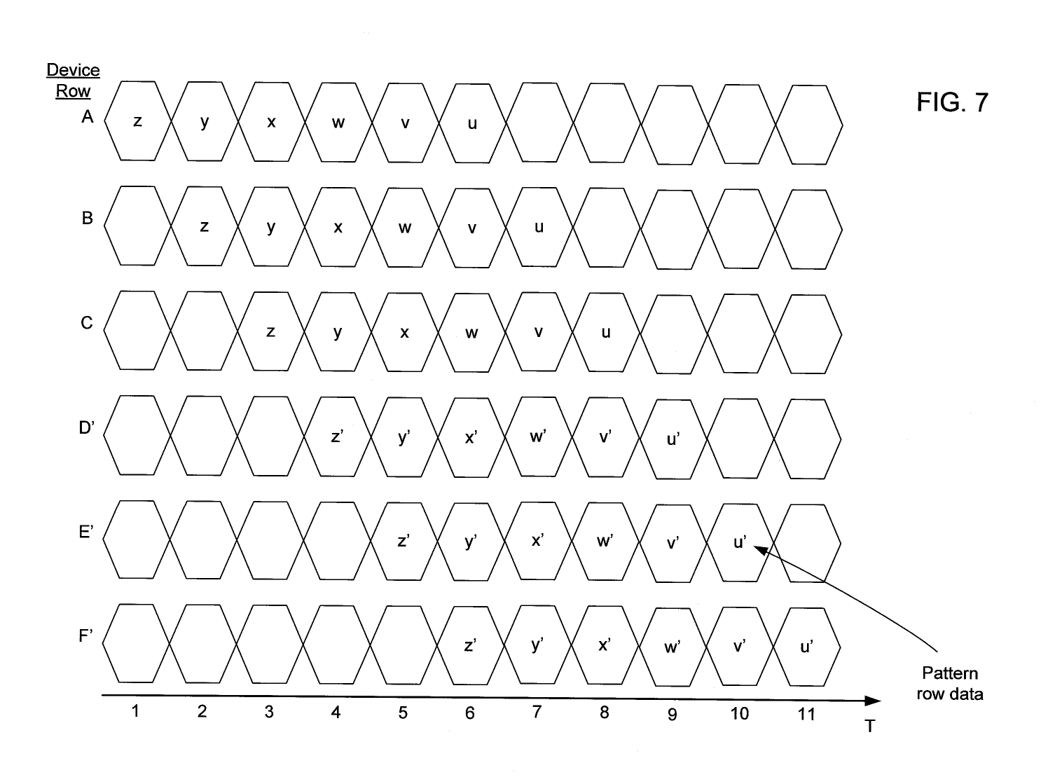

FIG. 7 is a timing diagram for the generation of patterns using the two offset arrays of FIG. 5 to generate the pattern shown in FIG. 4B in accordance with an embodiment of the invention. As shown, only the first array 502 is selectively reflecting pixel portions of the beam at times T=1 to 3. At time T=1, device row A in the first array 502 is used to generate pattern row z. At time T=2, device rows A and B in the first array 502 are used to generate pattern rows y and z, respectively. At time T=3, device rows A-C in the first array 502 are used to generate pattern rows x-z, respectively.

As further shown, from T=4 to T=8, both the first and second arrays (502 and 504) are selectively reflecting pixel portions of the beam. At time T=4, device rows A-C in the first array 502 are used to generate pattern rows w-y, respectively, and device row D′ in the second (offset) array 504 is used to generate pattern row z′. At time T=5, device rows A-C in the first array 502 are used to generate pattern rows v-x, respectively, and device rows D′ and E′ in the second array 504 are used to generate pattern rows y′ and z′, respectively. At time T=6, device rows A-C in the first array 502 are used to generate pattern rows u-w, respectively, and device rows D′-F′ in the second array 504 are used to generate pattern rows x′-z′, respectively. At time T=7, device rows B and C in the first array 502 are used to generate pattern rows u and v, respectively, and device rows D′-F′ in the second array 504 are used to generate pattern rows w′-y′, respectively. At time T=8, device row C in the first array 502 is used to generate pattern row u, and device rows D′-F′ in the second array 504 are used to generate pattern rows v′-x′, respectively.

Lastly, at times T=9 to 11, only the second array 504 is selectively reflecting pixel portions of the beam. At time T=9, device rows D′-F′ are used to generate pattern rows u′-w′, respectively. At time T=10, device rows E′ and F′ are used to generate pattern rows u′ and v′, respectively. Finally, at time T=11, device row F′ is used to generate pattern row u′. Thereafter, at time T=12, the projection of the high-density interlaced pattern onto the target substrate is complete, such that none of the pattern rows need to be generated by the offset dual array.

Second High-Density Array

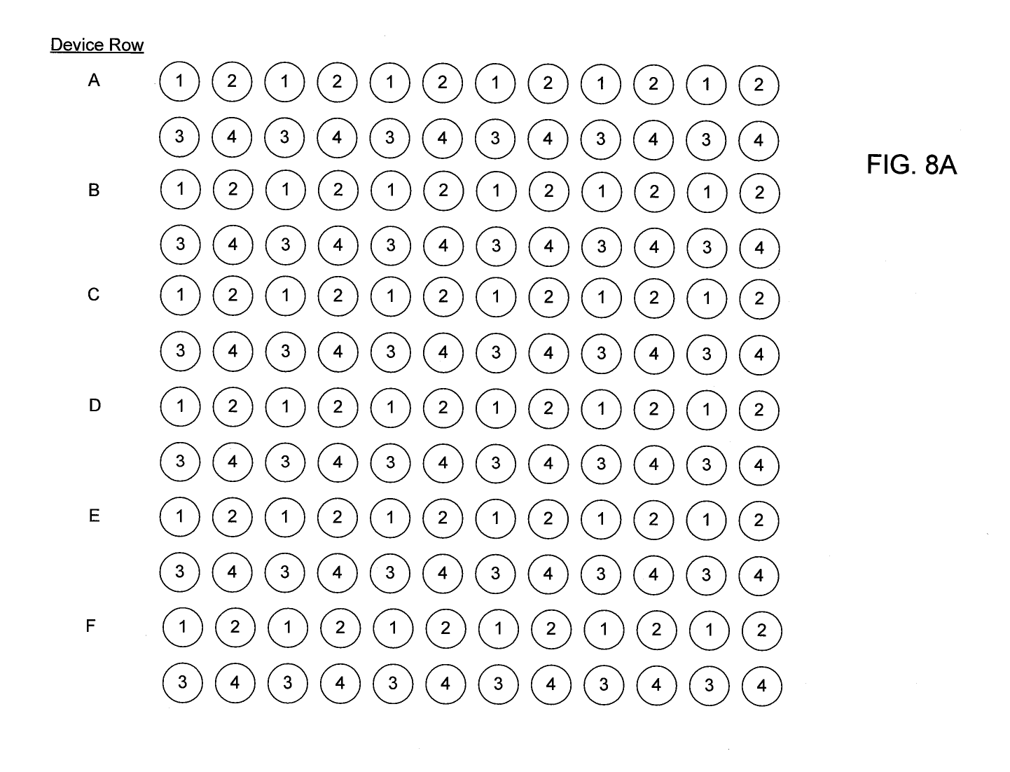

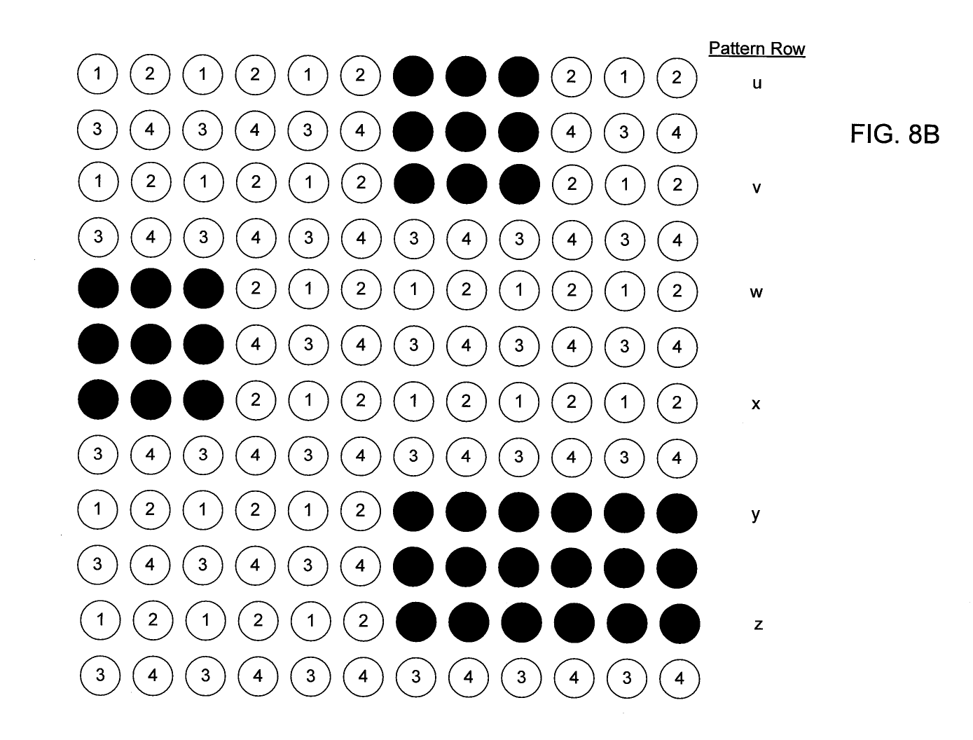

FIG. 8A is a diagram depicting another high-density array of pixel element devices that may be impractical to implement due to the size of the underlying transistor cells. As shown, the high-density array may be considered to be formed from four sub-arrays: a first sub-array has devices labeled 1; a second sub-array has devices labeled 2; a third sub-array has devices labeled 3; and a fourth sub-array has devices labeled 4. Each sub-array has six rows A through F.

FIG. 8B is a diagram depicting an example pattern which may be desired to be generated by the high-density array shown in FIG. 8A. The black filled circles represent the (unblurred) location pixels of the pattern that are to be written by impingment of the beam, while the unfilled circles represent the (unblurred) location of pixels of the pattern that are to be left unwritten. Note that, in the actual pattern written on the target substrate, each pixel would be blurred so as to effectively fill gaps between adjacent “on” pixels at the surface of the target substrate.

Unfortunately, similar to the high-density array shown in FIG. 4A, the array shown in FIG. 8A may be impractical to implement due to the size of the underlying transistor cells. For example, the size of the underlying transistor cells may be such that the highest possible density of pixel element devices may be the density in one of the sub-arrays. In other words, there may be no space underneath the surface for the transistor cells of the second (interlaced) sub-array. An innovative solution to this problem is described below.

Four Offset Arrays

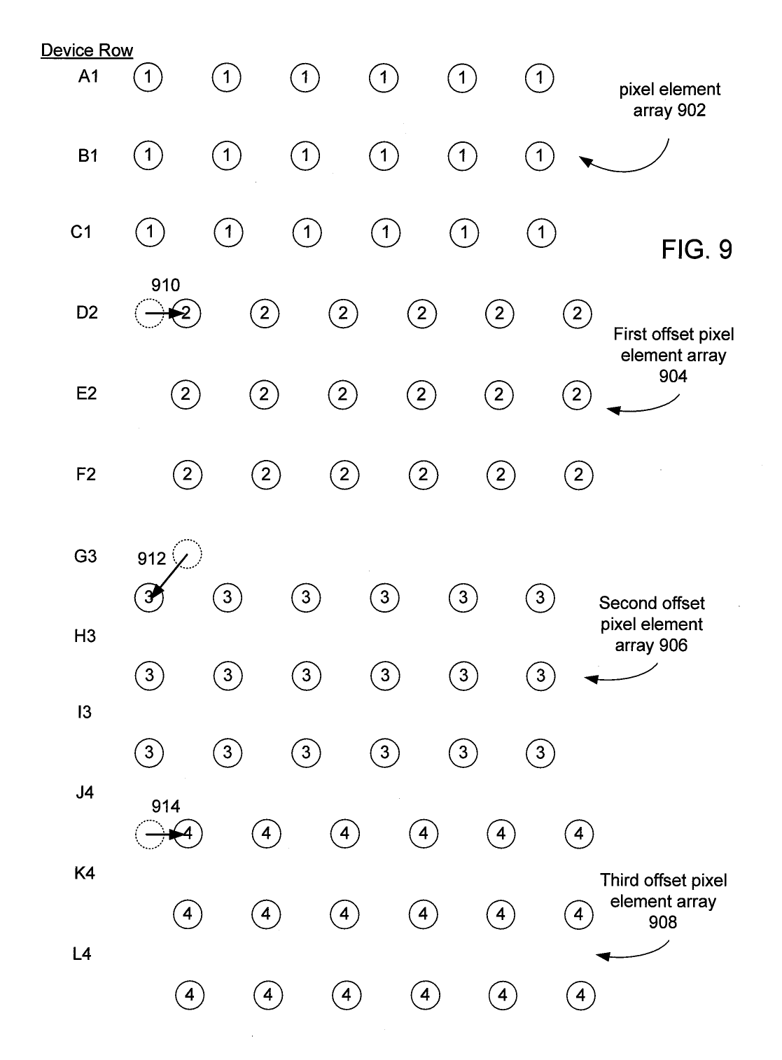

FIG. 9 is a diagram depicting four offset arrays of pixel element devices that effectively functions as a high-density array in accordance with an embodiment of the invention. Shown are four arrays which are offset from each other. In this simple example, the first array 902 includes device rows A1 through C1, the second array 904 includes device rows D2 through F2, the third array 906 includes device rows G3 to 13, and the fourth array 908 includes device rows J4 to L4.

The positions of the pixel elements in the four arrays are offset from each other. The offset between the first and second arrays may be represented by a first offset vector 910. The offset between the second and third arrays may be represented by a second offset vector 912. Lastly, the offset between the third and fourth arrays may be represented by a third offset vector 914.

In this example, rows A1 to C1 in the first array 902 correspond to rows A to C of the sub-array labeled 1 in FIG. 8A. Rows D2 to F2 in the second array 904 correspond to rows D to F of the sub-array labeled 2 in FIG. 8A. Rows G3 to I3 in the third array 906 correspond to rows G to I of the sub-array labeled 3 in FIG. 8A. Lastly, rows J4 to L4 in the fourth array 908 correspond to rows J to L of the sub-array labeled 4 in FIG. 8A.

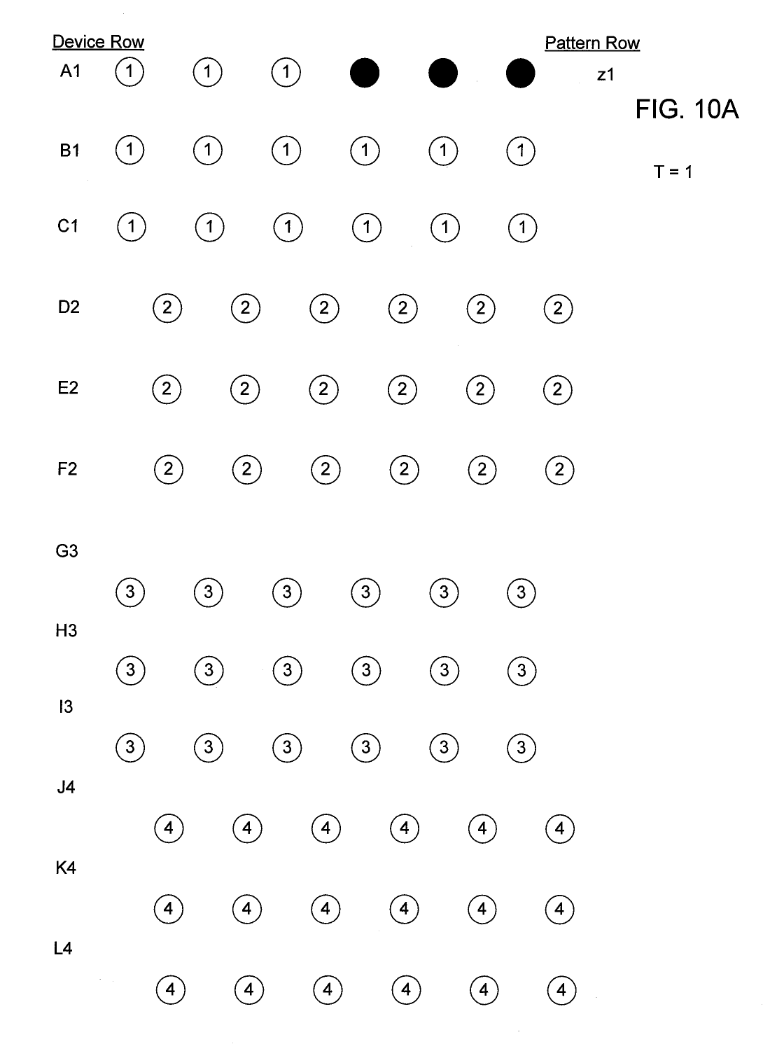

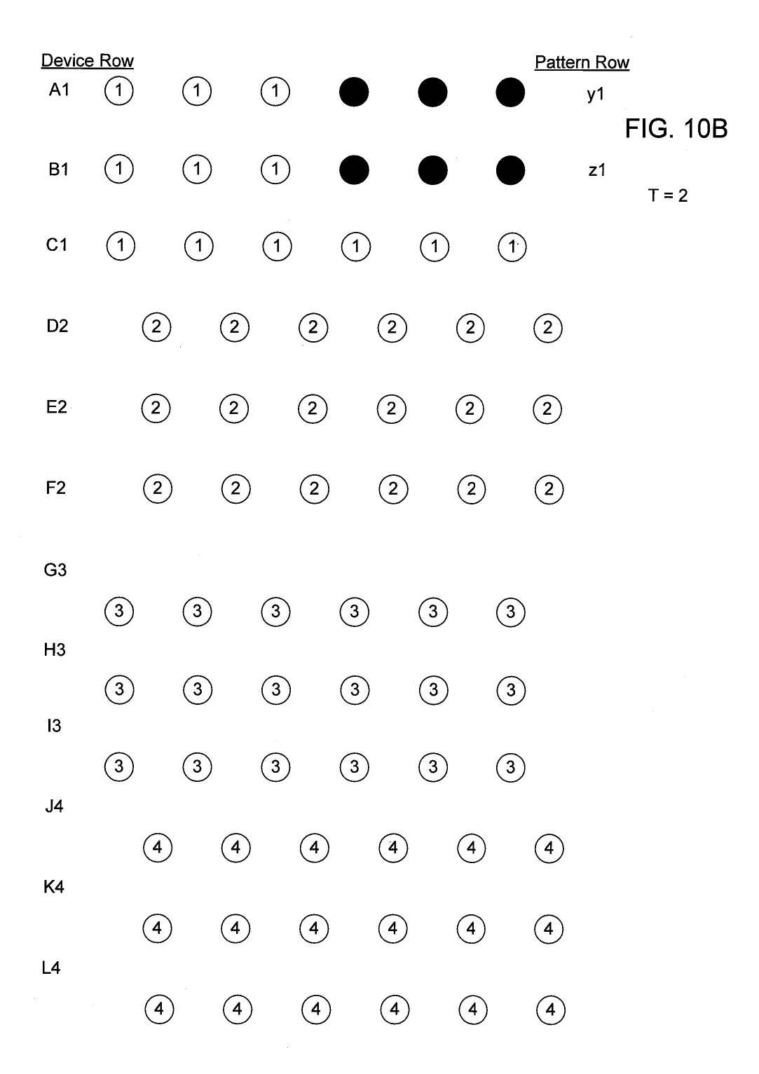

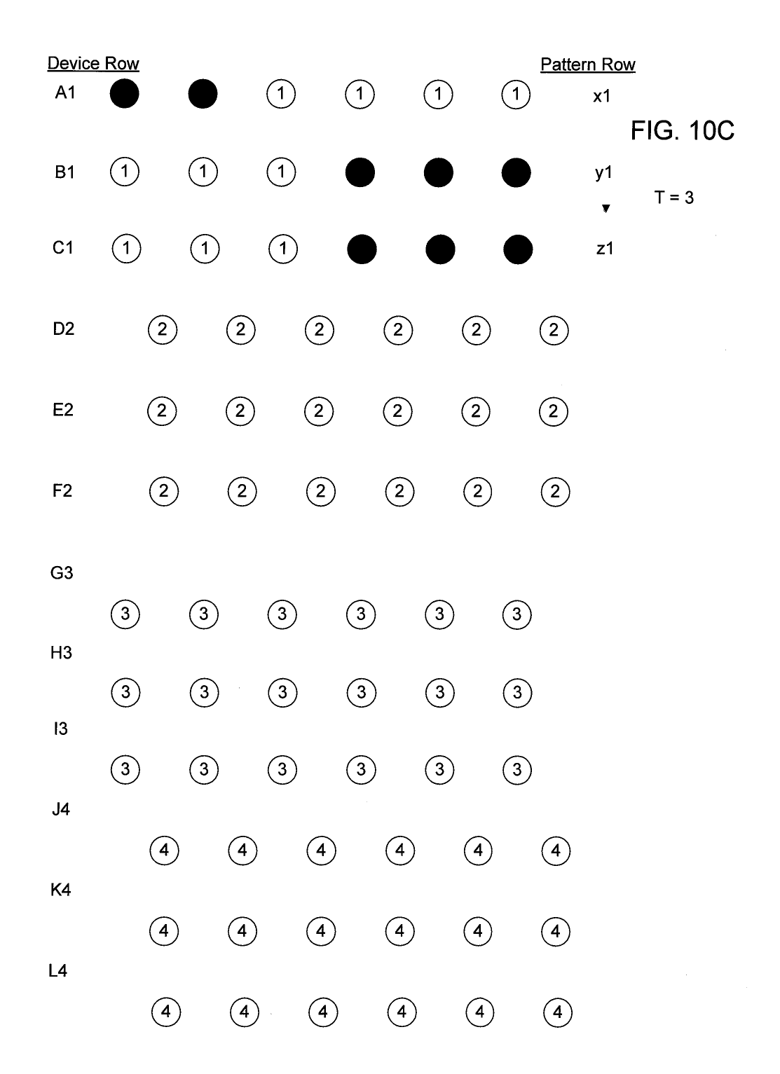

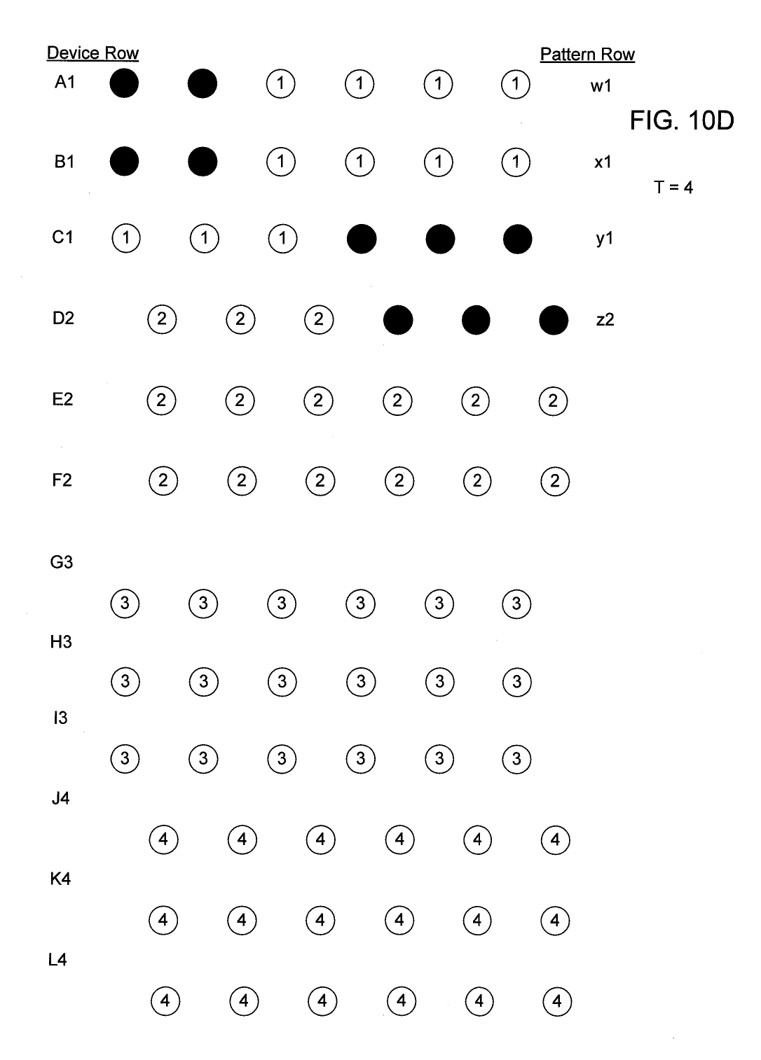

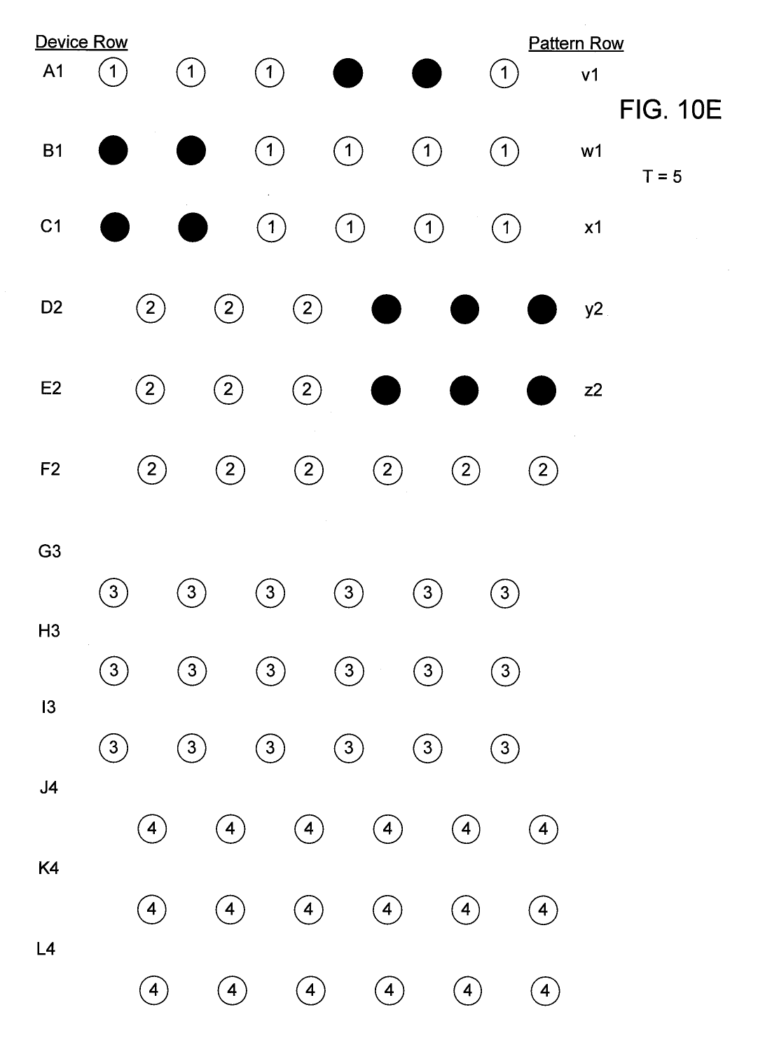

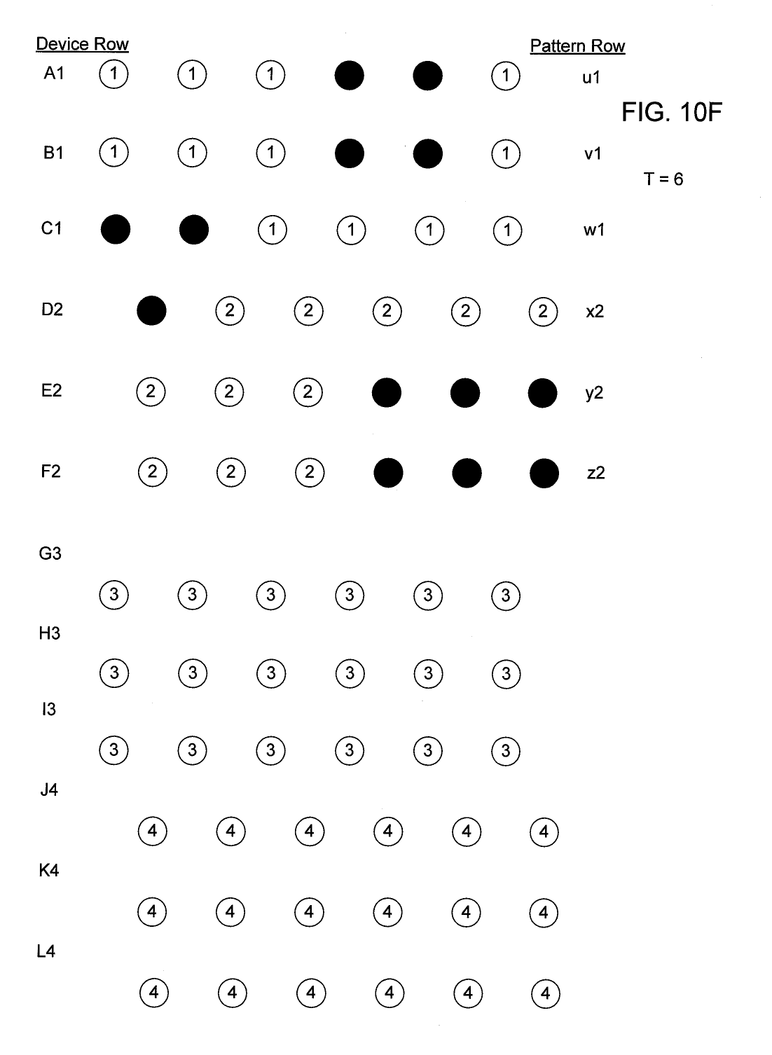

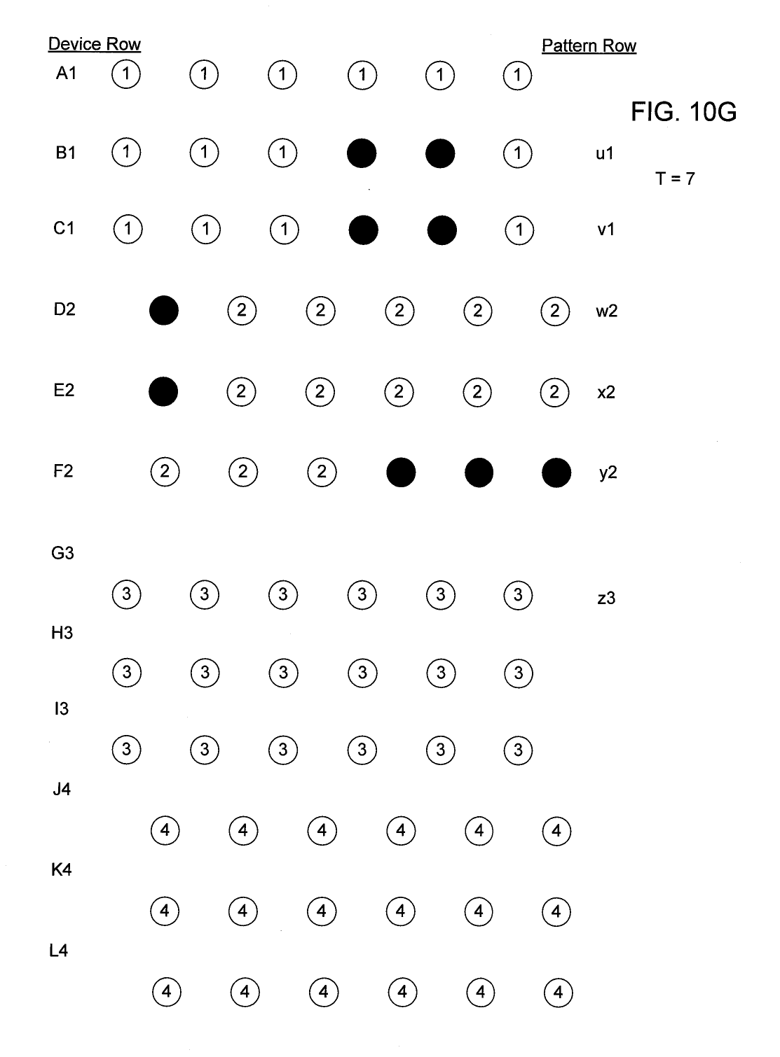

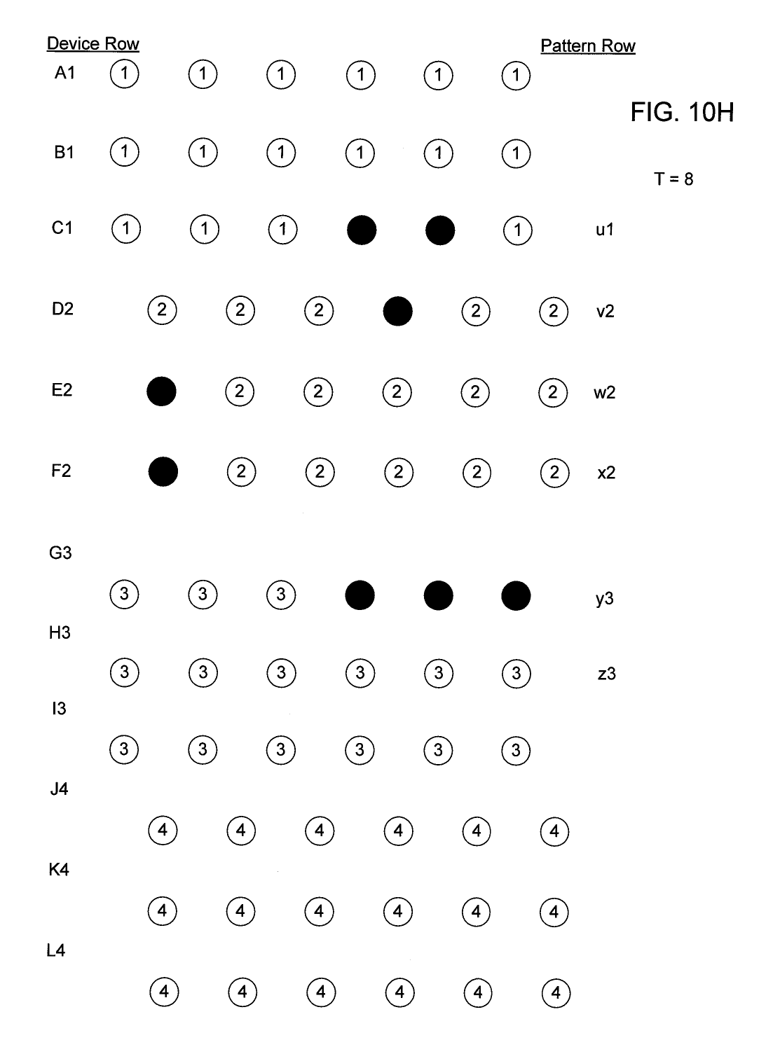

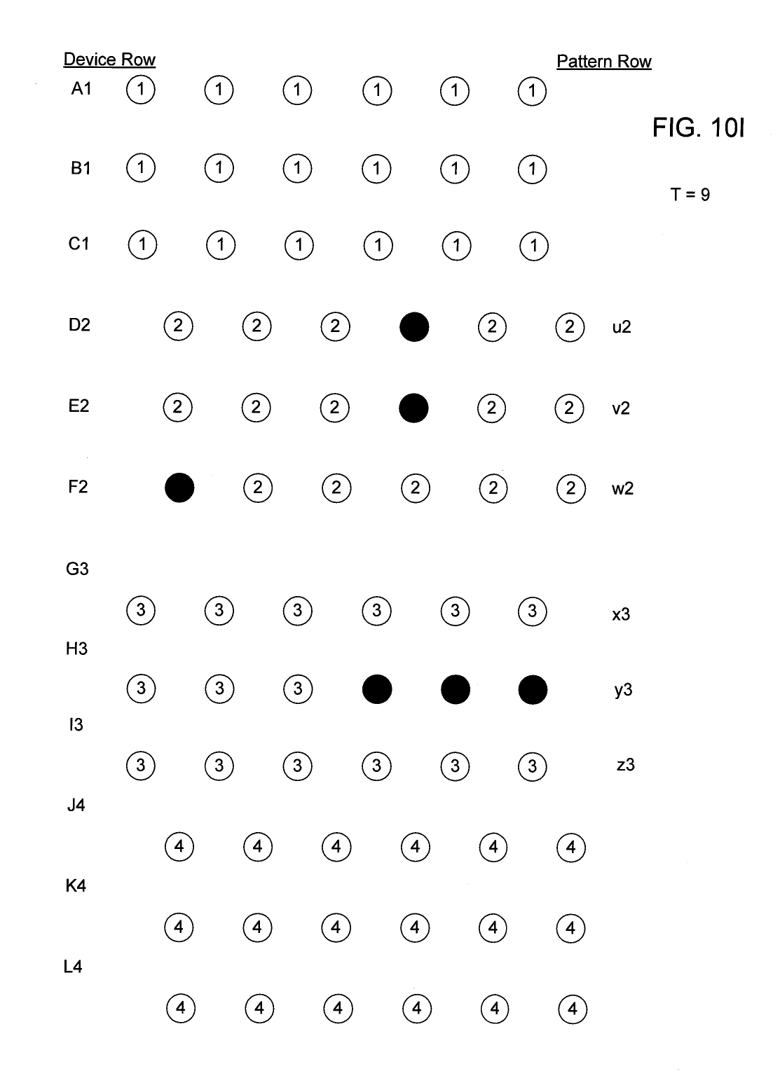

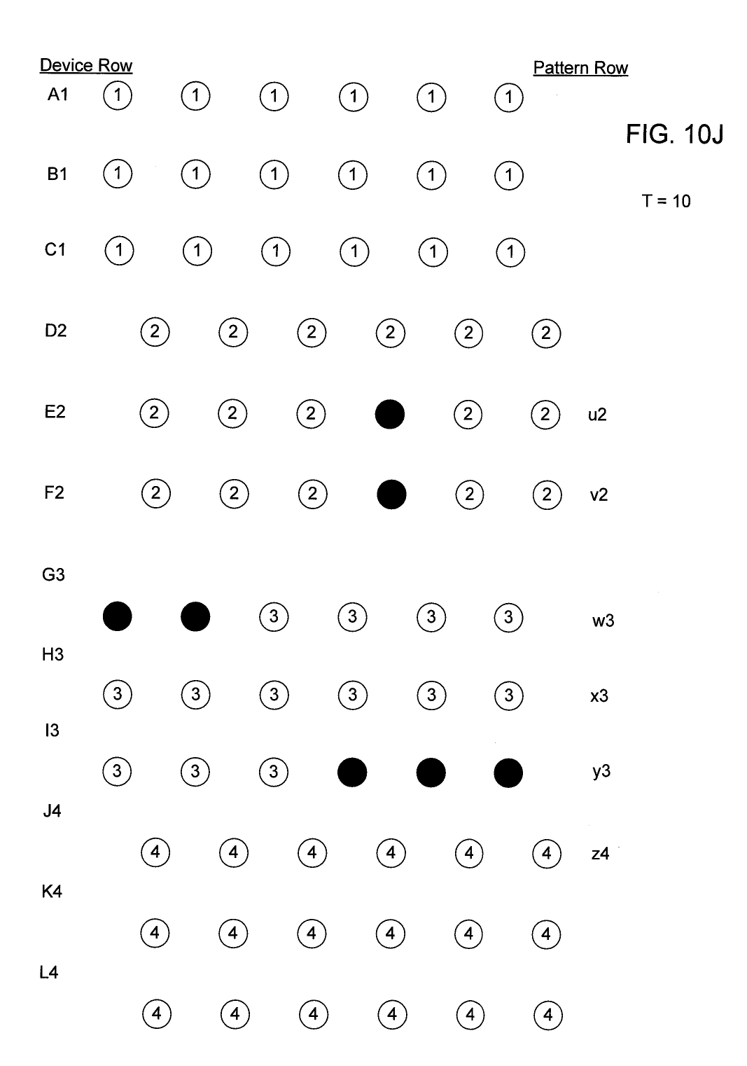

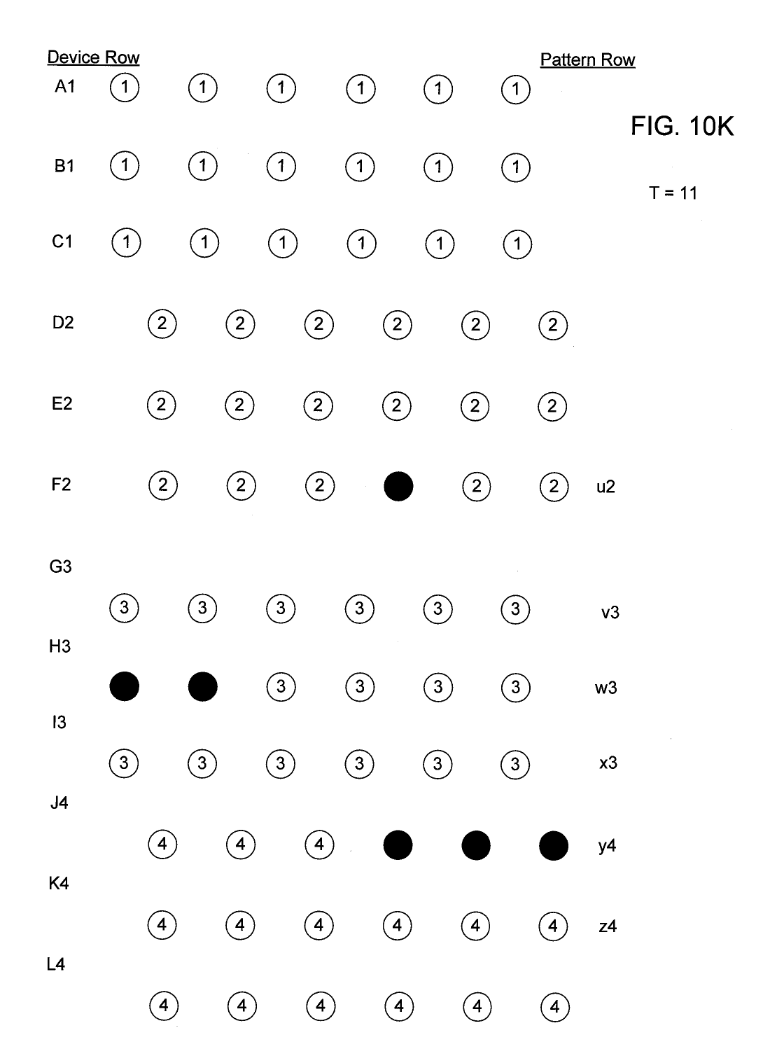

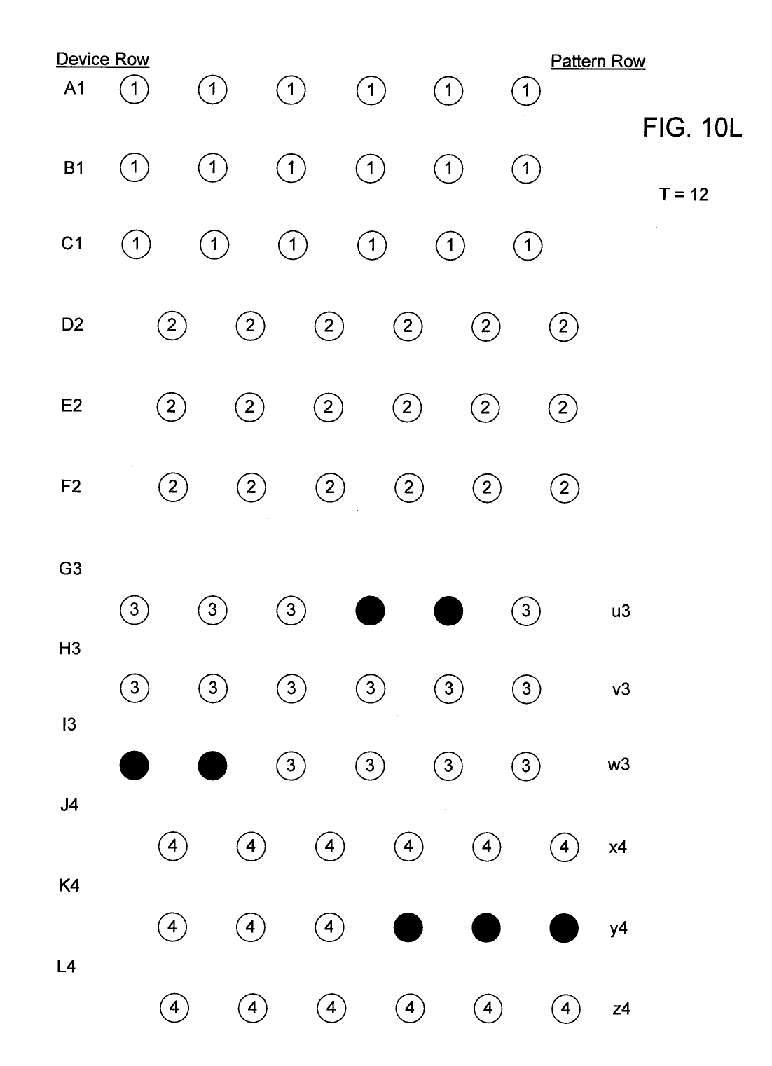

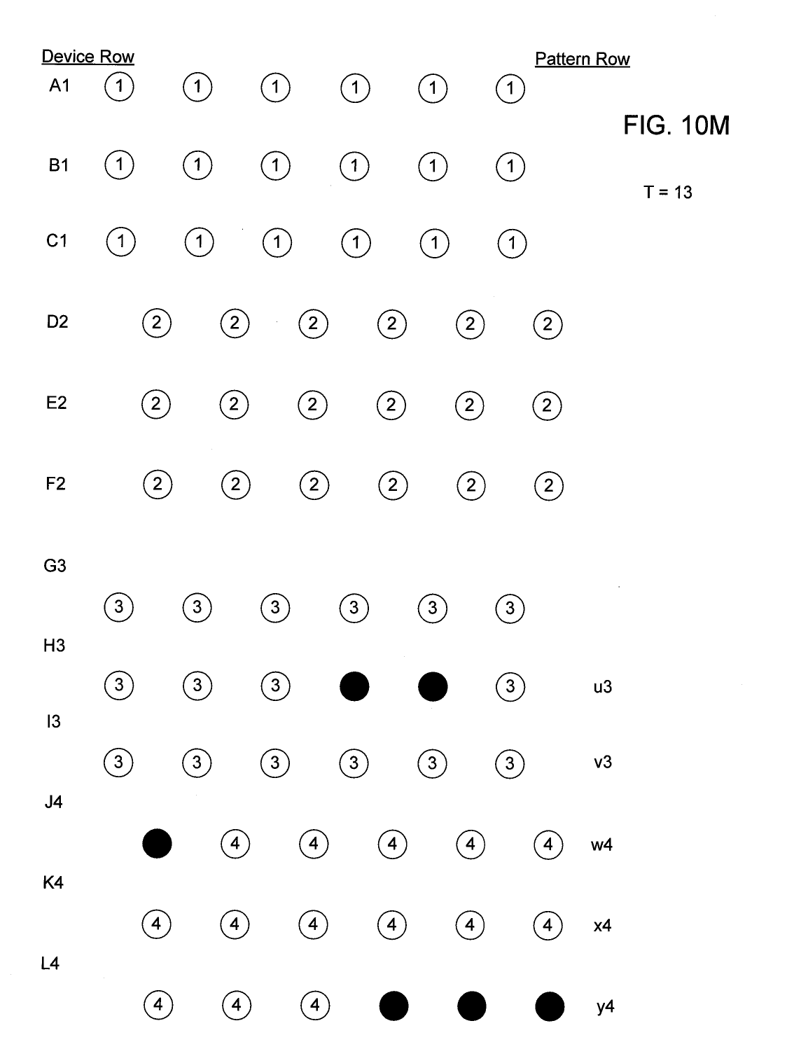

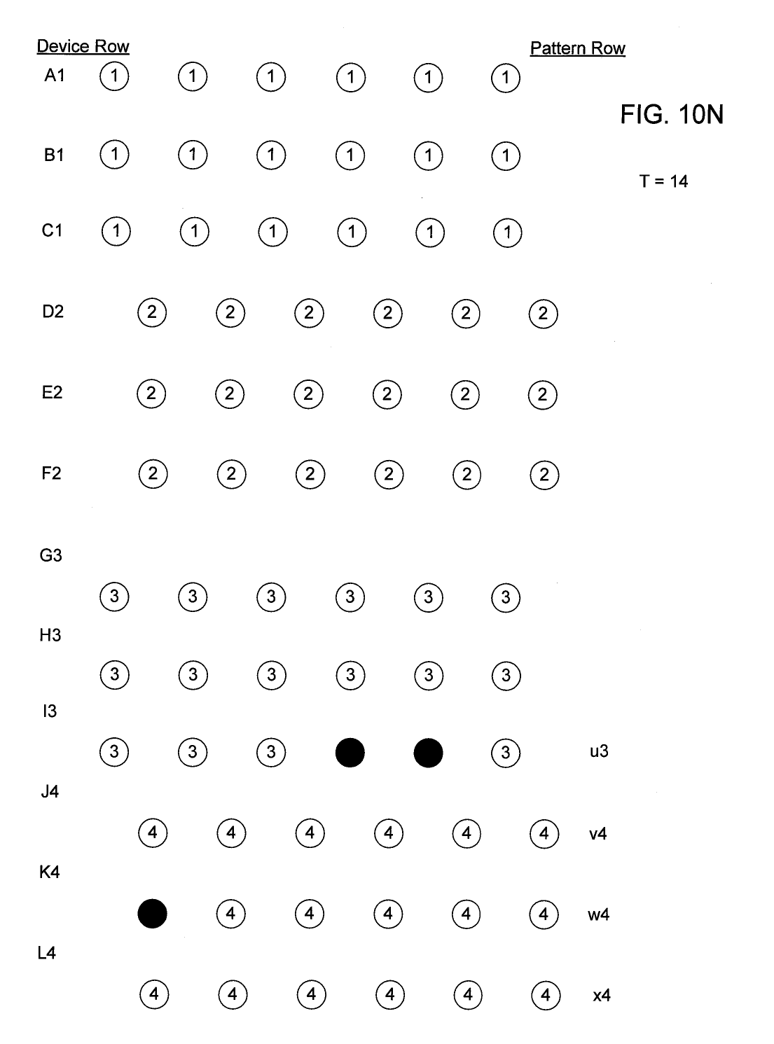

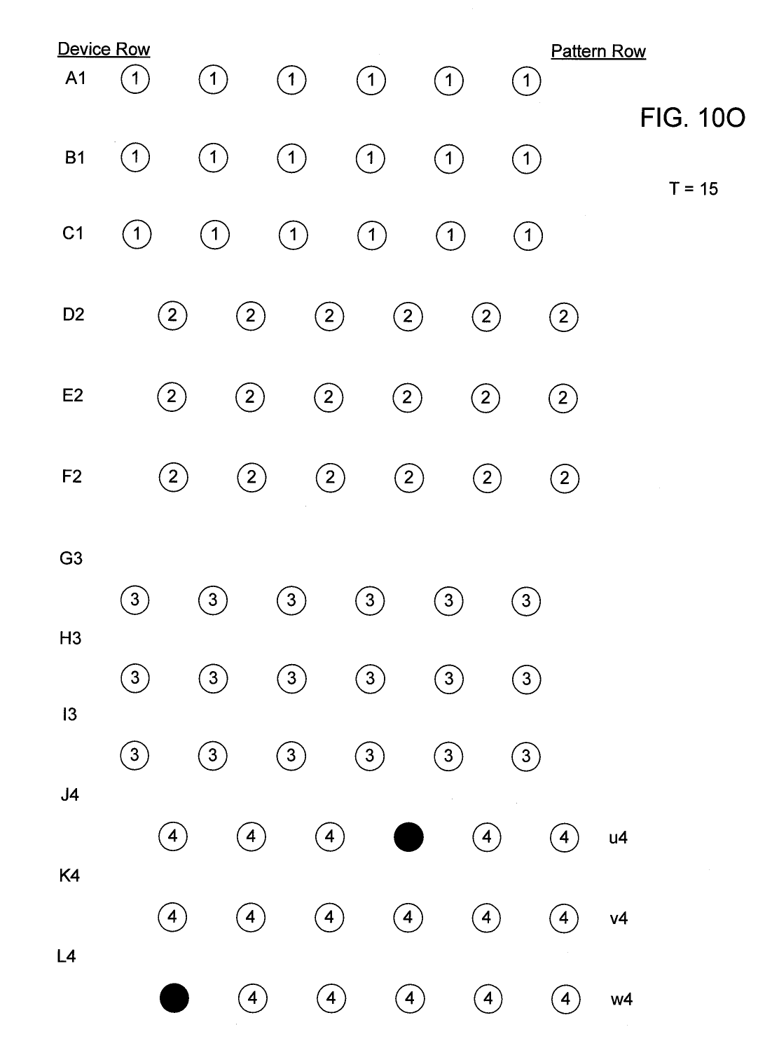

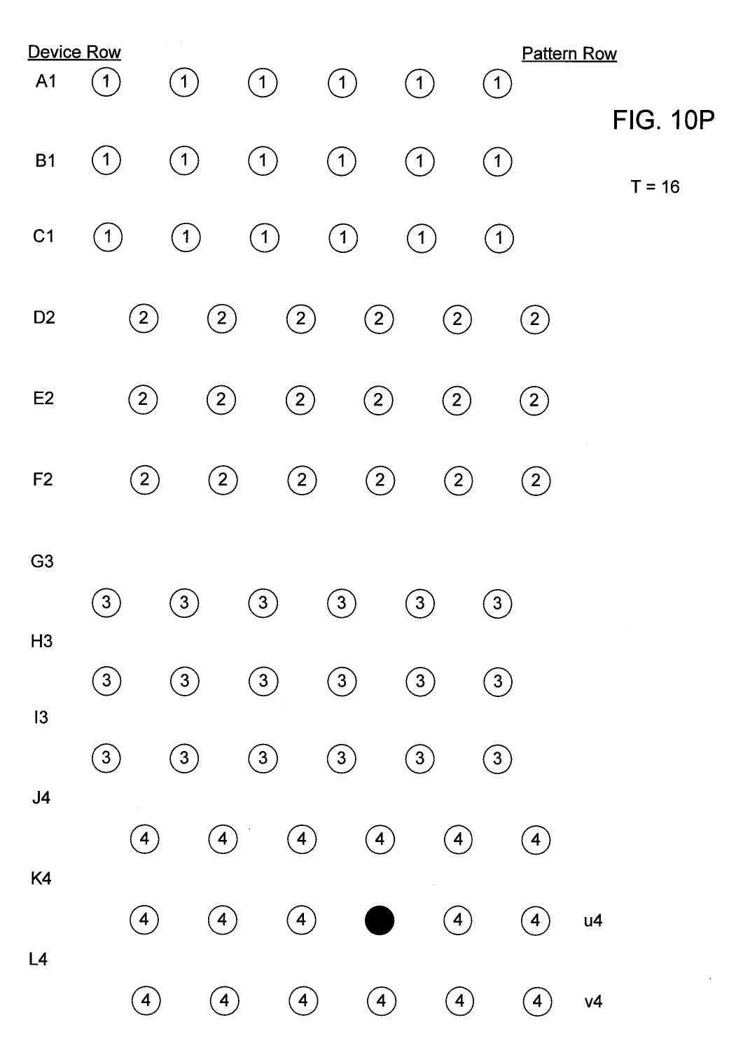

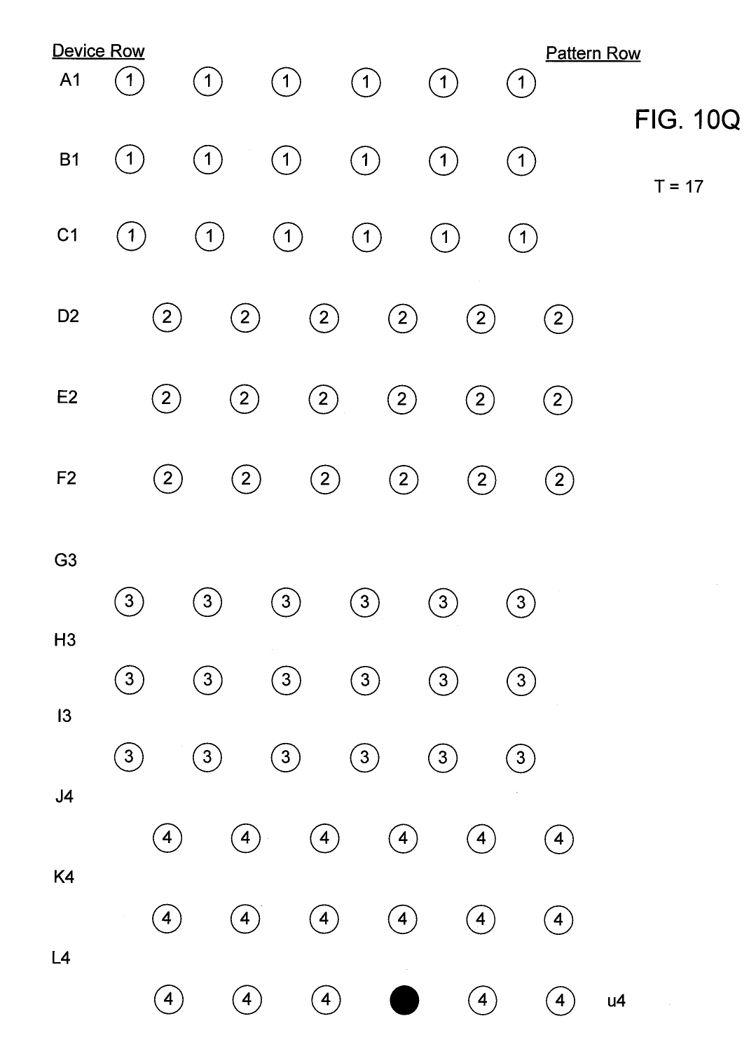

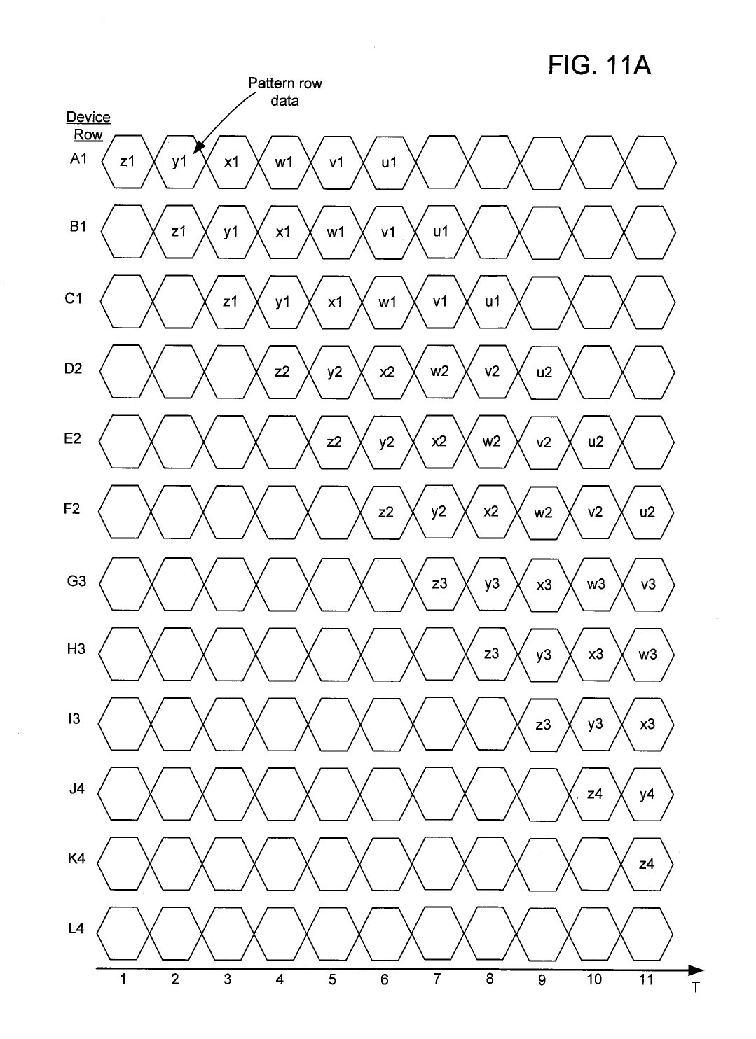

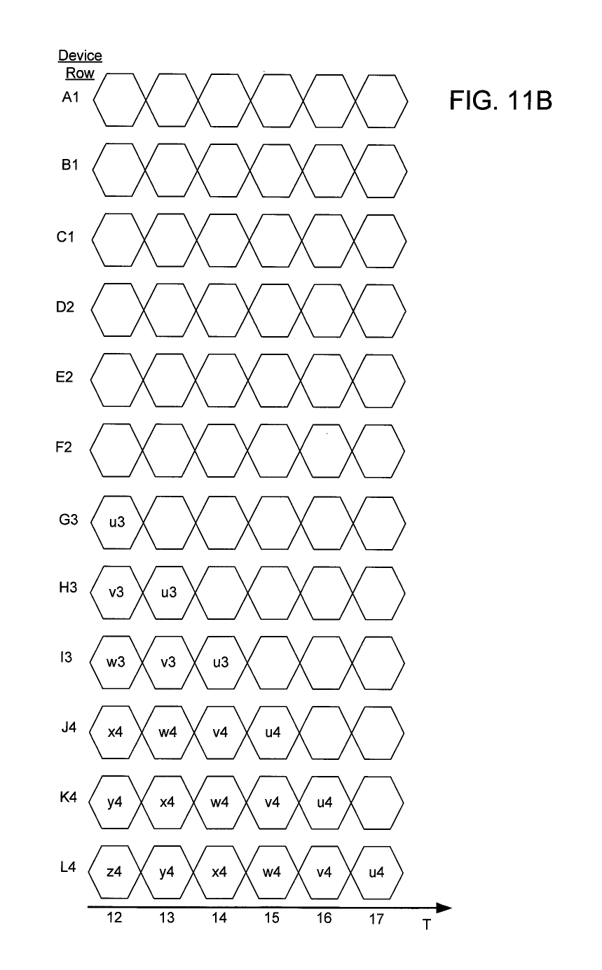

FIGS. 10A-10Q comprise a sequence of diagrams depicting the generation of the example pattern of FIG. 8B by the four offset arrays of FIG. 9 in accordance with an embodiment of the invention. FIGS. 11A and 11B provide a timing diagram corresponding to the sequence of diagrams in FIGS. 10A-10Q.

At time T=1, device row A1 in the first array 902 is used to generate pattern row z1.

At time T=2, device rows A1 and B1 in the first array 902 are used to generate pattern rows y1 and z1, respectively.

At time T=3, device rows A1-C1 in the first array 902 are used to generate pattern rows x1-z1, respectively.

At time T=4: device rows A1-C1 in the first array 902 are used to generate pattern rows w1-y1, respectively; and device row D2 in the second array 904 is used to generate pattern row z2.

At time T=5: device rows A1-C1 in the first array 902 are used to generate pattern rows v1-x1, respectively; and device rows D2 and E2 in the second array 904 are used to generate pattern rows y2 and z2, respectively.

At time T=6: device rows A1-C1 in the first array 902 are used to generate pattern rows u1-w1, respectively; and device rows D2-F2 in the second array 904 are used to generate pattern rows x2-z2, respectively.

At time T=7: device rows B1 and C1 in the first array 902 are used to generate pattern rows u1 and v1, respectively; device rows D2-F2 in the second array 904 are used to generate pattern rows w2-y2, respectively; and device row G3 in the third array 906 is used to generate pattern row z2.

At time T=8: device row C1 in the first array 902 is used to generate pattern row u1; device rows D2-F2 in the second array 904 are used to generate pattern rows v2-x2, respectively; and device rows G3 and H3 in the third array 906 are used to generate pattern rows y3 and z3.

At time T=9: device rows D2-F2 in the second array 904 are used to generate pattern rows u2-w2, respectively; and device rows G3-I3 in the third array 906 are used to generate pattern rows x3-z3.

At time T=10: device rows E2 and F2 in the second array 904 are used to generate pattern rows u2 and v2, respectively; device rows G3-I3 in the third array 906 are used to generate pattern rows w3-y3; and device row J4 in the fourth array 908 is used to generate pattern row z4.

At time T=11, device row F2 in the second array 904 is used to generate pattern row u2, respectively; device rows G3-I3 in the third array 906 are used to generate pattern rows v3-x3; and device rows J4 and K4 in the fourth array 908 are used to generate pattern rows y4 and z4.

At time T=12, device rows G3-I3 in the third array 906 are used to generate pattern rows v3-x3; and device rows J4 and K4 in the fourth array 908 are used to generate pattern rows y4 and z4.

At time T=13, device rows H3 and I3 in the third array 906 are used to generate pattern rows u3 and v3; and device rows J4-L4 in the fourth array 908 are used to generate pattern rows w4-y4.

At time T=14, device row I3 in the third array 906 are used to generate pattern row u3; and device rows J4-L4 in the fourth array 908 are used to generate pattern rows v4-x4.

At time T=15, device rows J4-L4 in the fourth array 908 are used to generate pattern rows u4-w4, respectively, and device rows

At time T=16, device rows K4 and L4 in the fourth array 908 are used to generate pattern rows u4 and v4, respectively.

At time T=17, device row L4 in the fourth array 908 is used to generate pattern row u4.

Thereafter, at time T=18, the projection of the high-density interlaced pattern onto the target substrate is complete, such that none of the pattern rows need to be generated by the four arrays.

While the present application describes embodiments of the invention the utilize two offset arrays and four offset arrays, other embodiments of the invention may use other numbers of offset arrays.

Example Apparatus

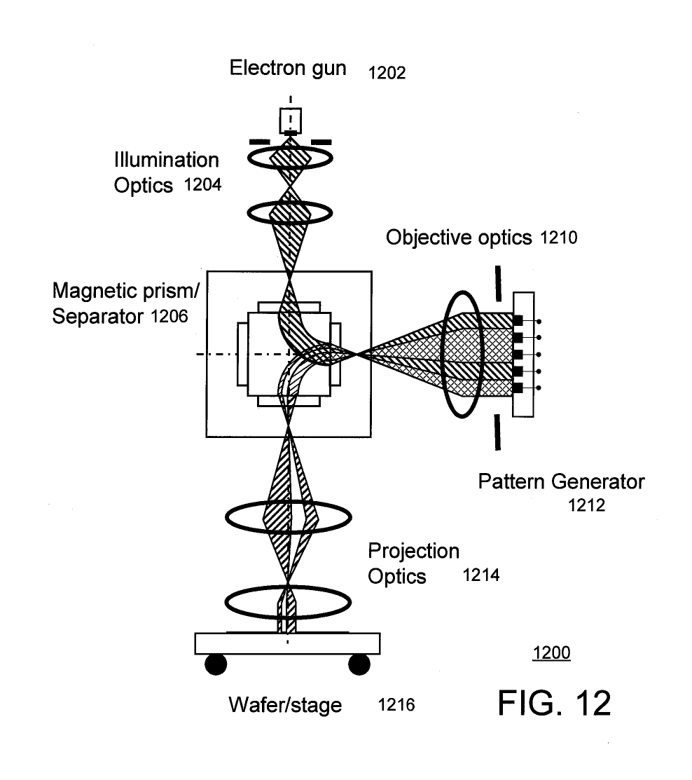

FIG. 12 is a schematic diagram of an example electron beam apparatus 1200 in which an embodiment of the invention may be implemented. In this particular example, the apparatus 1200 comprises to a reflection electron beam lithography or REBL system. As depicted, the apparatus 1200 includes an electron source 1202, illumination optics 1204, a magnetic prism 1206, an objective electron lens 1210, a dynamic pattern generator (DPG) 1212, projection optics 1214, and a movable stage 1216 for holding a wafer or other target to be lithographically patterned. Note that, in this case, the illumination, objective and projection optics (1204, 1210, and 1214) operate on an electron beam and so are actually electron-optics (which may be implemented by generating appropriate electrostatic and/or magnetic fields). In accordance with an embodiment of the invention, the various components of the system 1200 may be implemented as follows.

The electron source 1202 may be implemented so as to supply a large current at low brightness (current per unit area per solid angle) over a large area. The large current is to achieve a high throughput rate. The apparatus 1200 should preferably control the energy of the electrons so that their turning points (the distance above the DPG 1212 at which they reflect) are relatively constant, for example, to within about 100 nanometers. To keep the turning points to within about 100 nanometers, the electron source 1202 would preferably have a low energy spread of no greater than 0.5 electron volts (eV).

The illumination optics 1204 is configured to receive and collimate the electron beam from the source 1202. The illumination optics 1204 allows the setting of the current illuminating the pattern generator structure 1212 and therefore determines the electron dose used to expose the substrate. The illumination optics 1204 may comprise an arrangement of magnetic and/or electrostatic lenses configured to focus the electrons from the source 1202. The specific details of the arrangement of lenses depend on specific parameters of the apparatus and may be determined by one of skill in the pertinent art.

The magnetic prism 1206 is configured to receive the incident beam from the illumination optics 1204. When the incident beam traverses the magnetic fields of the prism, a force proportional to the magnetic field strengths acts on the electrons in a direction perpendicular to their trajectory (i.e. perpendicular to their velocity vectors). In particular, the trajectory of the incident beam is bent towards the objective lens 1210 and the dynamic pattern generator 1212.

Below the magnetic prism 1206, the electron-optical components of the objective optics are common to the illumination and projection subsystems. The objective optics may be configured to include the objective lens 1210 and one or more transfer lenses (not shown). The objective optics receives the incident beam from the prism 1206 and decelerates and focuses the incident electrons as they approach the DPG 1212. The objective optics is preferably configured (in cooperation with the gun 1202, illumination optics 1204, and prism 1206) as an immersion cathode lens and is utilized to deliver an effectively uniform current density (i.e. a relatively homogeneous flood beam) over a large area in a plane above the surface of the DPG 1212. In one specific implementation, the objective lens 1210 may be implemented to operate with a system operating voltage of 50 kilovolts. Other operating voltages may be used in other implementations.

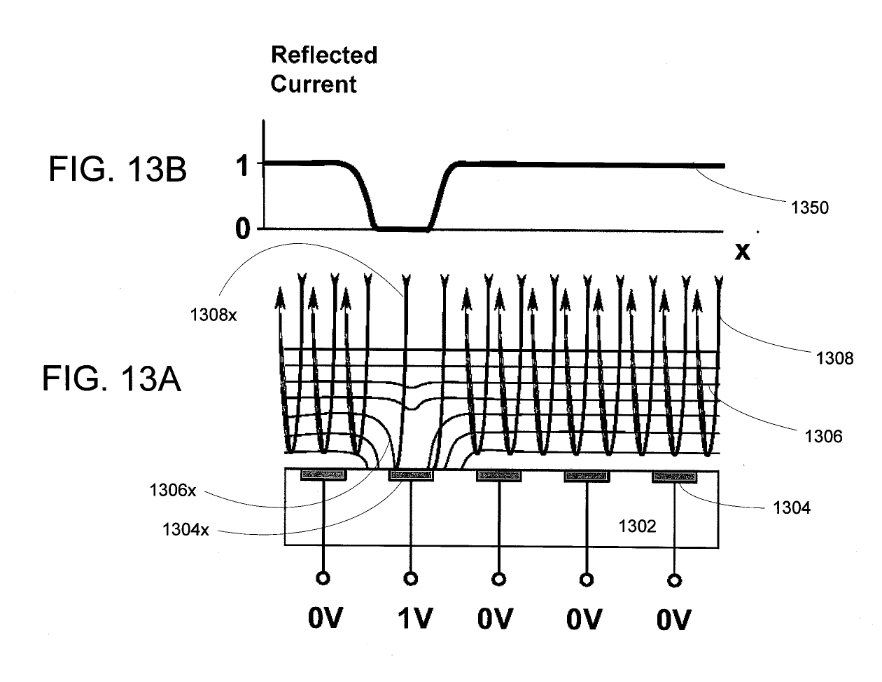

In accordance with an embodiment of the invention, the dynamic pattern generator 1212 comprises arrays of pixel elements as described above. Each pixel element may comprise, for example, a metal contact to which a voltage level is controllably applied. The principle of operation of the DPG 1212 is described further below in relation to FIGS. 13A and 13B.

The extraction part of the objective lens 1210 provides an extraction field in front of the DPG 1212. As the reflected electrons leave the DPG 1212, the objective optics 1210 is configured to accelerate the reflected electrons toward their second pass through the prism 1206. The prism 1206 is configured to receive the reflected electrons from the objective optics 1210 and to bend the trajectories of the reflected electrons towards the projection optics 1214.

The projection electron-optics 1214 reside between the prism 1206 and the wafer stage 1216. The projection optics 1214 is configured to focus the electron beam and demagnify the beam onto photoresist on a wafer or onto another target. The demagnification may be, for example, 100x demagnification (i.e. 0.01× magnification). The blur and distortion due to the projection optics 1214 may be a fraction (or more) of the pixel size.

The wafer stage 1216 holds the target wafer. In one embodiment, the stage 1216 is in linear motion during the lithographic projection. In another embodiment, the stage 116 may be in rotational motion during the lithographic projection. Since the stage 1216 is moving, the pattern on the DPG 1212 may be dynamically adjusted (for example, by the timed shifting of the pattern across the DPG, as discussed above) to compensate for the motion such that the projected pattern moves in correspondence with the wafer movement. In other embodiments, the apparatus 1200 may be applied to other targets besides semiconductor wafers. For example, the apparatus 1200 may be applied to reticles. The reticle manufacturing process is similar to the process by which a single integrated circuit layer is manufactured.

FIGS. 13A and 13B are diagrams illustrating the basic operation of a dynamic pattern generator. FIG. 13A shows a cross-section of a DPG substrate 1302 showing a column (or row) of pixels. Each pixel includes a conductive area 1304. A controlled voltage level is applied to each pixel. In the example illustrated in FIG. 13A, four of the pixels 1304 are “on” (reflective mode) and are grounded (have 0 volts applied thereto), while one pixel (with conductive area labeled 1304x) is “off” (absorptive mode) and has a positive voltage (1 volt) applied thereto. The specific voltages will vary depending on the parameters of the system. The resultant local electrostatic equipotential lines 1306 are shown, with distortions 1306x relating to “off” pixel shown. In this example, the incident electrons 1308 approaching the DPG 1212 come to a halt in front of and are reflected by each of the “on” pixels, but the incident electrons 1308x are drawn into and absorbed by the “off” pixel. The resultant reflected current (in arbitrary units) is shown in FIG. 13B. As seen from FIG. 13B, the reflected current 1350 is “0” for the “off” pixel and “1” for the “on” pixels.

The above-described diagrams are not necessarily to scale and are intended be illustrative and not limiting to a particular implementation. In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An apparatus for writing a pattern on a target substrate, the apparatus comprising:
a plurality of arrays of pixel elements, each array being offset from the other arrays;
a source and lenses for generating an incident beam that is focused onto the plurality of arrays;
circuitry to control the pixel elements of each array to selectively reflect pixel portions of the incident beam to form a patterned beam; and
a projector for projecting the patterned beam onto the target substrate.

2. The apparatus of claim 1, further comprising:
a movable stage for moving the target substrate under the patterned beam; and
circuitry to shift pattern data over the plurality of arrays in synchronization with the movement of the target substrate.

3. The apparatus of claim 2, wherein the multiple arrays comprise two arrays offset from each other, and wherein the pattern generated is an interlaced pattern.

4. The apparatus of claim 2, wherein the multiple arrays comprise four arrays offset from each other.

5. The apparatus of claim 2, wherein each array writes a different subset of pixels of the pattern onto the target substrate.

6. The apparatus of claim 2, wherein each pixel of the pattern is written by only one array of the plurality of arrays.

7. The apparatus of claim 1, wherein the incident beam is an incident electron beam, and wherein voltages are controllably applied to the pixel elements to selectively reflect the pixel portions of the incident electron beam.

8. The apparatus of claim 1, wherein the incident beam is an incident optical beam, and wherein the pixel elements are controlled to selectively reflect pixel portions of the incident optical beam.

9. A method of writing a pattern on a target substrate, the method comprising:
generating an incident beam that is focused onto the plurality of arrays; and
controlling pixel elements of a plurality of arrays to selectively reflect pixel portions of the incident beam to form a patterned beam,
wherein the positions of the pixel elements of each array are offset from the positions of the pixel elements of the other array(s).

10. The method of claim 9, further comprising:
moving the target substrate under the patterned beam; and
shifting pattern data over the plurality of arrays in synchronization with the movement of the target substrate.

11. The method of claim 10, wherein the multiple arrays comprise two arrays offset from each other, and wherein the pattern generated is an interlaced pattern.

12. The method of claim 10, wherein the multiple arrays comprise four arrays offset from each other.

13. The method of claim 10, wherein each array writes a different subset of pixels of the pattern onto the target substrate.

14. The method of claim 10, wherein each pixel of the pattern is written by only one array of the plurality of arrays.

15. The method of claim 9, wherein the incident beam is an incident electron beam, and wherein voltages are controllably applied to the pixel elements to selectively reflect the pixel portions of the incident electron beam.

16. The method of claim 9, wherein the incident beam is an incident optical beam, and wherein the pixel elements are controlled to selectively reflect pixel portions of the incident optical beam.
